(19) United States
(12) Patent Application Publication
(10) Pub. No.: US 2014/0149167 A1
(43) Pub. Date: May 29, 2014

(54) SYSTEM AND METHOD FOR A CONFIGURABLE AND EXTENSIBLE ALLOCATION AND SCHEDULING TOOL

(71) Applicant: Clevest Solutions Inc., Richmond (CA)

(72) Inventors: Arthur Pui Wing Lo, Richmond (CA); Kenny Wai-doon Louie, Richmond (CA); Patrick-Alain Joseph Numainville, Richmond (CA); Donald Edward Marquardt, Richmond (CA); William Tak-Chou Lee, Richmond (CA); Shuk Lee Wendy Lee, Richmond (CA); Lily Anne Ligocki, Richmond (CA)

(73) Assignee: Clevest Solutions Inc., Richmond (CA)

(21) Appl. No.: 14/171,668

(22) Filed: Feb. 3, 2014

Related U.S. Application Data
(63) Continuation of application No. 12/634,497, filed on Dec. 9, 2009, now abandoned.

(30) Foreign Application Priority Data
Nov. 19, 2009 (CA) 2686210

(51) Int. Cl. G06Q 10/10

(52) U.S. Cl. CPC G06Q 10/1097
USPC 705/7.21

(57) ABSTRACT

A system provides a GUI allocation and scheduling tool that enables a user to configure and apply Schedule Flows that include scheduling logic statements, filters, matching functions, scheduling engines and Objective Functions to appropriately assign a plurality of jobs to a plurality of workers and resources. The user may add, delete and/or edit scheduling logic statements, filters, matching criteria, scheduling engines and Objective Functions to produce appropriate scheduling outcomes according to user definable objectives. The GUI tool also enables a user to evaluate scheduling outcomes and assess the effectiveness of Schedule Flows and scheduling logic statements by configuring and applying evaluation criteria. The system's platform architecture provides software interfaces that enable the integration of custom matching functions, scheduling engines and Objective Functions, and third party hardware and software functionality.

### RELATED APPLICATIONS

The present application is a continuation of U.S. patent application Ser. No. 12/634,497, filed Dec. 9, 2009 entitled “A SYSTEM AND METHOD FOR A CONFIGURABLE AND EXTENSIBLE ALLOCATION AND SCHEDULING TOOL,” which claims priority from Canadian patent application no. 2686210 filed on Nov. 19, 2009 and entitled “A SYSTEM AND METHOD FOR A CONFIGURABLE AND EXTENSIBLE ALLOCATION AND SCHEDULING TOOL,” the entire disclosures of which are hereby incorporated by reference herein in their entirety.

### FIELD OF INVENTION

The present invention relates to systems that assist the management, allocation and scheduling of a plurality of scheduling populations.

### BACKGROUND OF THE INVENTION

Many businesses use application software to assist with the task of assigning and scheduling jobs with workers and resources. Typical scheduling applications match jobs with workers by processing predefined rules and parameters with predefined methods. The use of predefined rules and parameters do not allow the scheduling application to readily adapt to changes in job requirements, worker resources, worker skills, and human preferences. As businesses undergo changes to their scheduling requirements, the scheduling outcomes produced from predefined rules, parameters and methods may not be appropriate and satisfactory, and may be very different from an optimized schedule produced from human processing with additional constraints and requirements. The rules, parameters and methods of the scheduling software may need to be rewritten to satisfy new scheduling objectives. Rewriting the scheduling software is costly in terms of financial resources and in terms of the system downtime that is needed to recompile the software and test the application. Further downtime may be involved where errors in the new software are identified and/or additional modifications are needed.

Scheduling applications generally process numerous rules and parameters to produce scheduling outcomes to satisfy a multitude of essential criteria. However, scheduling applications typically do not provide a means for users and programmers to identify the particular effects and changes made to scheduling outcomes from the processing of specific rules and parameters. The ability to identify the effects of applying particular rules and parameters is necessary to enable users and programmers to effectively evaluate, create and/or modify rules and parameters to satisfy scheduling needs and objectives.

A multitude of scheduling options may be produced in the process of generating an optimized schedule involving a plurality of jobs requiring a plurality of workers and a plurality of resources. Scheduling applications generally determine the appropriate application of scheduling options by performing evaluation methods that measure a scheduling option's degree of effectiveness according to particular criteria. Prior scheduling applications typically employ evaluation methods that are created as predefined rules that are hard coded and cannot be readily modified to accommodate changes in scheduling objectives. Additions, modifications or deletions of rules and evaluation methods require rewriting the program and involve significant downtime.

Scheduling applications may provide users with analytical tools to enable users to evaluate the effectiveness of scheduling outcomes. Prior scheduling systems typically provide analytical methods, rules and criteria that are created in accordance with a business' scheduling objectives at a particular point in time. The analytical methods, rules and criteria are generally hard coded and cannot be readily modified to accommodate changes in scheduling objectives. Means to allow analytical methods, rules and criteria to be readily modified and applied is necessary to enable analytical information to be adaptable and relevant to changes in a business' scheduling objectives, and enable users to make effective decisions on the use of scheduling outcomes. A method that allows analytical methods, rules and criteria to be dynamically modified without disrupting the operability of the scheduling system is required.

While scheduling applications produce scheduling outcomes to assist users they must also allow users to retain control of the scheduling process and adjust the results as necessary. However, adjusting schedules in prior scheduling applications typically involve an inefficient procedure of cancelling particular scheduled jobs and workers, redefining the scheduling parameters, and reprocessing all unassigned jobs and workers. The procedure must be repeated until a new schedule that satisfies the scheduling objectives is created. An alternative solution is to manually reschedule particular jobs and workers and also manually reschedule all jobs, workers, and resources that are affected. Manual rescheduling is often impractical and inefficient when a multitude of jobs, workers, and resources are involved. What is required is a method that enables users to efficiently and conveniently override particular results of a scheduling outcome by manipulating assignments and/or by processing rules and parameters, and further processing rules and parameters to schedule any unassigned and/or affected jobs, workers, and resources.

Each business may also require unique functions and features in a scheduling tool, which may vary across industries and over time. A method of extensibility is needed to accommodate the unanticipated requirements of different businesses, which may involve custom functions and the integration of third party hardware and software functionality. Extensibility enables a scheduling application to incorporate custom functions without the need for programmers to rewrite the system application.

### SUMMARY OF THE INVENTION

What is needed and is herein presented is a scheduling application that assists the task of scheduling by providing a GUI tool that offers scheduling outcomes processed according to user configurable Schedule Flows that include scheduling logic statements, filters, matching functions, scheduling engines and Objective Functions. The GUI tool also enables the user to add, remove, and/or modify scheduling logic statements, filters, matching functions, scheduling engines and Objective Functions to produce scheduling outcomes that satisfy user defined scheduling objectives. The GUI tool provides the user with means to identify the changes made to a prior scheduling outcome from adding, modifying and/or deleting, one, or a plurality, of scheduling logic statements, filters, matching functions, scheduling engines and/or Objective Functions. The GUI tool allows a user to override and adjust the results of a scheduling outcome and further process additional scheduling logic as required. The system's platform architecture enables the use and/or modification of matching functions, scheduling engines, Objective Functions, exit methods, analytical methods and criteria without the need to rewrite the program and without causing any system downtime. Published interfaces are provided to enable the system to incorporate custom functions and third party hardware and software functionality.

The present invention is a scheduling system that assists users in managing the scheduling and assignment of jobs, resources and workers. The scheduling system increases efficiency and reduces human error by performing the complex and time consuming calculations involved in assigning a multitude of jobs to numerous workers in accordance to a Schedule Flow. The scheduling system provides a graphical user interface (GUI) tool that allows a user to configure Schedule Flows that include scheduling logic statements, filters, scheduling engines, matching functions, Objective Functions and Exit Functions that are used to process the appropriate assignment of jobs, resources and workers.

The user may generate different scheduling outcomes by creating, editing and/or deleting scheduling logic statements, filters, and by applying and/or modifying scheduling methods including scheduling engines, matching functions, Objective Functions and Exit Functions. Different scheduling outcomes may also be produced by modifying the processing sequence of scheduling logic statements, filters, scheduling engines, matching functions, Objective Functions and Exit Functions.

The GUI tool enables users to apply configurable filters to create subsets of jobs, resources and workers, according to specific criteria, such as location, job duration, technical requirements, and labour rates. Filters enable users to focus on particular subsets of matching populations in the processing of Schedule Flows to optimize scheduling outcomes.

Each business may require the use of different or unique matching criteria in the scheduling of jobs, workers and resources. The particular matching criteria required by a business' scheduling needs may be processed by a matching function. A plurality of matching functions may be created and made available for use in the system to satisfy businesses with a plurality of scheduling needs and scenarios.

The appropriateness of each generated scheduling option may be measured according to its ability to satisfy specific objectives and criteria, such as minimizing costs and time, and/or maximizing capacity. The scheduling tool enables the system to evaluate the appropriateness of scheduling options according to user defined objectives and criteria through the processing of Objective Functions. Objective Functions are algorithms and methods that perform particular calculations based on user defined objectives, criteria and evaluative parameters to measure the appropriateness of applying a particular scheduling option. A plurality of Objective Functions may be created and made available for use in the system. Users may configure the use of particular Objective Functions in Schedule Flows to enable the system to determine and apply appropriate scheduling options.

The system may incorporate and apply methods referred to as Exit Methods to determine and appropriately cease further calculations for generating and optimizing scheduling outcomes when particular conditions are met. The user may configure particular conditions for an Exit Method through the GUI tool. Users may also configure an appropriate maximum and/or minimum time used in generating and optimizing scheduling outcomes.

The system allows user specific analytical methods to be created and incorporated to evaluate scheduling outcomes and scheduling processes. The requirements for analytical methods and criteria may vary across businesses and change over time. Changes may be made to analytical methods and criteria without disrupting the operability of the system.

The GUI tool provides a progress bar to show a graphic representation of the amount of time that has lapsed in the processing of a Schedule Flow. Users may interrupt the processing of a Schedule Flow at any point in time and view the scheduling assignments that have been generated up to that particular point in time.

The system's platform architecture enables a plurality of scheduling engines, matching functions, Objective Functions, Exit Methods and Analytical methods to be incorporated and applied. Scheduling engines, matching functions, Objective Functions, Exit Methods and analytical methods may be uniquely created to satisfy the specific needs of a particular business and be integrated by the system through published software interfaces and by allowing data to be queried from and returned to the system. The use of published interfaces allows user specific scheduling engines, matching functions, Objective Functions, Exit Methods and analytical methods to be independently upgraded or modified without causing any downtime, and to also remain compatible with the system when upgrades or modifications are made to the system's main code stream.

The GUI tool enables users to configure user screens that are implemented by the user to execute Schedule Flows. User-defined screens may also be configured to display aggregate results from the prior processing of Schedule Flows. Displaying aggregate results on the prior processing of Schedule Flows provides the end user with information to assess the progress and effectiveness of Schedule Flow configurations and to make modifications to Schedule Flows as required. A user-defined screen may also be created to enable users to configure Exit Method conditions and values.

The GUI tool provides users with a graphic means to identify and review the changes made to scheduling outcomes from the addition, modification, and/or deletion of scheduling logic statements, filters, scheduling engines, matching functions, Objective Functions or Exit Methods, and the reconfiguration of the processing sequence of scheduling logic statements, filters, scheduling engines, matching functions, Objective Functions or Exit Methods.

The user may choose to accept, reject or override scheduling outcomes. The GUI tool provides users with a “Sandbox” method to manipulate and optimize assignments with drag-and-drop and/or point-and-click tools. The Sandbox method allows users to manually manipulate particular scheduling items to produce preferred assignments without the need to firstly unassign the selected items, and also allows users to specify particular assignments to remain unaffected in the processing of further scheduling actions.

The GUI tool also provides a search function that allows users to search for available matches according to configurable criteria.

Once defined, a Schedule Flow may be stored in the database for use by the system. Each Schedule Flow with configured user screen definitions, scheduling logic statements, filters, matching function, scheduling engine, Objective Function, and Exit Method may be created for each step of a scheduling process of a business entity. Multiple Schedule Flows may be created for business entities that require a plurality of steps for a scheduling process. Such Schedule Flows can be linked and run like a script through user-defined screens, which may be configured to show intermediate results for the user to evaluate the effectiveness of each Schedule Flow.

The GUI tool enables a user to create and manipulate the Schedule Flow configurations, including scheduling logic statements, filters, scheduling engines, matching functions, Objective functions, Exit Methods, and user-screen configurations, and utilize them as part of the scheduling system without having to create custom code or recompile any parts of the system. The representation of Schedule Flows may be presented in a spoken language syntax convertible into XML code stored in the database and made available to the application. The Schedule Flows, which include the configuration of scheduling logic statements, filters, scheduling engines, matching functions, Objective functions, Exit Methods, and user-screen properties, for each scheduling process, forms part of a data entity referred to as a “Schedule_Type”. A Schedule_Type includes relevant data for a particular scheduling process and is stored in database for use when called by the system.

The system presented herein also provides a method of extensibility that allows the use of extensible code to execute custom functions that include the use of third party hardware and software. The system provides a published interface to integrate and implement custom functions of third party hardware and software, and consume web services that are outside of the scheduling system. A software interface is provided to link the system with external hardware and software and allow data to be queried from and returned to the system.

The system integrates extensible code to allow customer specific functions to be executed within the system without having to rewrite the main code stream of the application. The use of published interfaces allows both the extensible code and the main code stream to be independently upgraded or modified and remain mutually compatible. Therefore, customer specific extensible code does not need to be rewritten when upgrades or modifications are made to the system.

Other advantages of the present invention will become apparent from the detailed description of the invention and the illustrations provided herein.

A scheduling tool for scheduling a first scheduling population to a second scheduling population using a Schedule Run is provided, including a graphical user interface with a Schedule Flow editor for creating and configuring Schedule Flows by the creation, selection and editing of at least one of: a scheduling logic statement, or a prerequisite; a Screen Editor for editing a user screen associated with the Schedule Flow; and a plurality of data fields selectable for creating scheduling logic statements.

A system for scheduling a first scheduling population to a second scheduling population using a Schedule Run is provided, including a graphical user interface tool having: means for creating and editing a user screen associated with a Schedule Flow; means for configuring the Schedule Flow by selecting and editing a scheduling logic statements; means for configuring the Schedule Flow by selecting and editing a prerequisite element; and means for selecting a data field for use in the scheduling logic statements.

A method of allocating a first scheduling population to a second scheduling population is provided, including: editing a user screen associated with a Schedule Flow; configuring the Schedule Flow by selecting and editing a scheduling logic statement; configuring the Schedule Flow by selecting and editing a prerequisite element; storing a Schedule Flow configuration, including a user screen definition, the scheduling logic statement, and the prerequisite configuration as part of a Schedule Run; storing the Schedule Run as a Schedule_Type; and running the Schedule_Type to optimize allocation of the first scheduling population to the second scheduling population.

### BRIEF DESCRIPTION OF THE DRAWINGS

FIG. 1 illustrates a block diagram of an exemplary computing environment in which the present invention may be implemented according to one preferred embodiment.

FIG. 2 shows an embodiment of a graphical user interface tool according to the invention with its associated component areas for configuring Schedule Flows and user screens, and also illustrates the configuration of a Schedule Flow and the “Start” screen as outlined below in FIG. 6.

FIG. 3 illustrates an example of a work allocation schedule for three workers

FIG. 4 illustrates an alternative example of a work allocation schedule that satisfies a priority scheduling condition for a representative worker named “Bob”.

FIG. 5 illustrates a flowchart of cognitive steps that may be used to generate a schedule that satisfies the priority scheduling condition for a worker named “Bob”.

FIG. 6 Illustrates an example of an arrangement of user screens that may be used to execute the scheduling processes outlined in FIG. 5.

FIG. 7 and FIG. 8 illustrate an embodiment of graphical user interface according to the invention that enables users to configure scheduling filter parameters.

FIG. 9 illustrates an embodiment of the configuration of a Schedule Flow to schedule all remaining jobs to all workers, and the configuration of the “Schedule_All” screen outlined in FIG. 6.

FIG. 10 illustrates an embodiment of the configuration of a Schedule Flow and the “End_Result” screen outlined in FIG. 6.

FIG. 11 illustrates an embodiment of a Sandbox Scheduling tool according to the invention.

FIG. 12 illustrates an embodiment of the application of the “Start” screen through the Sandbox Scheduling tool.

FIG. 13 illustrates an embodiment of the application of the “Schedule_All” screen through the Sandbox Scheduling tool.

FIG. 14 illustrates an example of a scheduling allocation presented on the Sandbox Scheduling tool.

FIG. 15 illustrates a distribution of a plurality of job orders that are defined as “X” and “Y” across various work areas of two workers.

FIG. 16 illustrates a flowchart that outlines an example of the procedures for allocating jobs to workers in accordance to job type and work area preferences.

FIG. 17 through FIG. 20 illustrate the use of the GUI tool according to the invention to configure Schedule Flows and user screens that may be applied in the Sandbox Scheduling tool, which enable users to execute the scheduling processes outlined in FIG. 16.

FIG. 21 shows an example of code for an interface according to the invention that allows extensible code to access data fields in the database to perform custom functions.

FIG. 22 illustrates the manual manipulation of scheduling items through the Sandbox Scheduling tool according to the invention.

FIG. 23 illustrates the “Lock down” and “Floating” functions that may be applied in the Sandbox Scheduling tool according to the invention and the configuration of an allowable time interval for the assignment of a scheduling item.

FIG. 24 illustrates an example of a published interface for the Scheduling Engine according to the invention.

FIG. 25 illustrates an example of a published interface for the Objective Function according to the invention.

FIG. 26 illustrates an example of a published interface for the Match Maker function according to the invention.

FIG. 27 illustrates an embodiment of code for a Factory constructor according o the invention for the Factory Classes “Match Maker”, “Objective Function” and “Scheduling Engine” DLLs.

FIG. 28 illustrates a published interface that supplies aggregate values to user screens, analytical tools and third party APIs according to the invention.

FIG. 29 illustrates a flow chart that shows the system processes according to the invention during a typical Schedule Flow.

FIG. 30 illustrates a State Transition diagram that shows the system processes according to the invention during a typical Schedule Flow.

### DETAILED DESCRIPTION OF AN ILLUSTRATIVE EMBODIMENT

The invention and its principles may be produced in many different configurations, forms and materials. The drawings, illustrations and description of the invention herein are described with the understanding that the present disclosure is to be considered as an example of the principles of the invention and is not intended to limit the invention to the embodiment illustrated. Those skilled in the art will envision many possible variations within the scope of the present invention. To better appreciate the present invention it will be illustrated in an example embodiment within the context of scheduling job orders to workers.

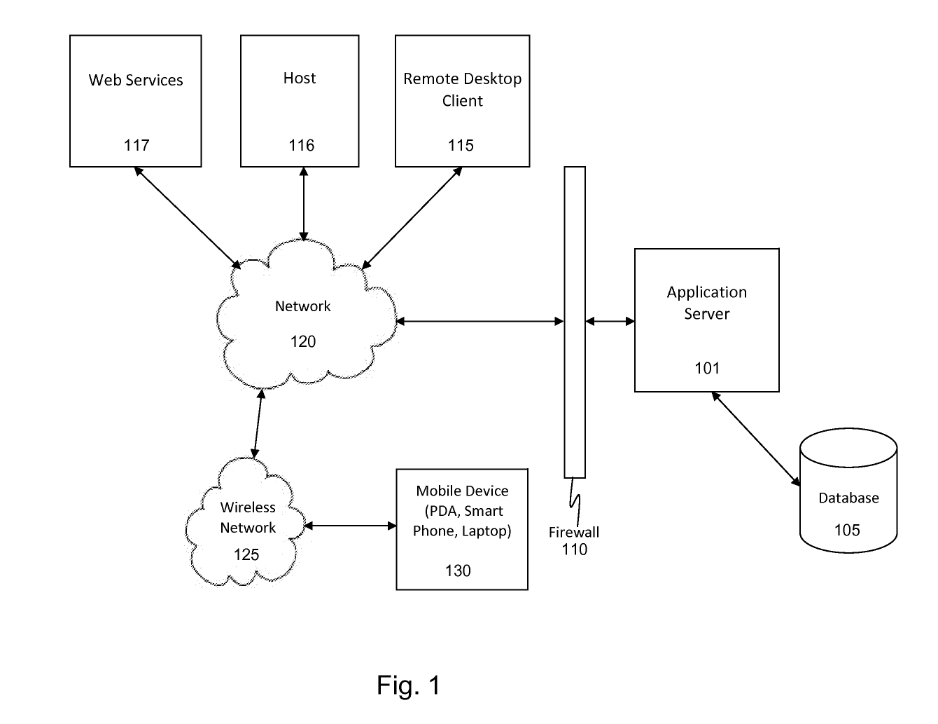

FIG. 1 shows an example of a computing environment in which the present invention may be implemented. Those skilled in the art will appreciate that the scheduling system may be implemented with other computer system configurations.

Remote desktop clients 115 and/or host 116 and wireless mobile clients 130 may access application server 101 and database 105 through wireless network 125 and/or network 120, such as the Internet. Host 116 provides and receives information regarding job orders to and from the application on server 101. Mobile devices 130 include portable computing devices that send and receive messages over wireless network 125, and/or devices that work in a disconnected mode and send and receive information when a network connection is established. Mobile devices are client devices, and include cellular phones, smart phones, PDAs, handheld computers, laptop computers, tablet computers, and the like. Database 105 is used to store information related to data fields, Schedule Flows, scheduling logic and application screens. The application may consume web services 117 that are accessed through network 120.

The scheduling system presented herein assists users in producing optimized schedules of allocated scheduling populations. A scheduling population may include one or more jobs or resources, or a combination of both jobs and resources. Resources include, but are not limited to, workers, equipment, parts, materials, commodities, manufactured goods, transportation vehicles, buildings, land and time. The example embodiment presented herein assists users in producing optimized schedules of allocated job orders to workers. The system allocates jobs to workers and/or other resources by performing a Schedule Run. A Schedule Run includes one or more Schedule Flows, which are each a user-configurable scheduling logic that manages one or more scheduling functions. The scheduling system provides a graphical user interface (GUI) tool to enable users to dynamically configure Schedule Flow elements, including scheduling logic statements, filters, matching functions, scheduling engines, and Objective Functions; which are used to generate appropriate allocations of jobs, resources and workers.

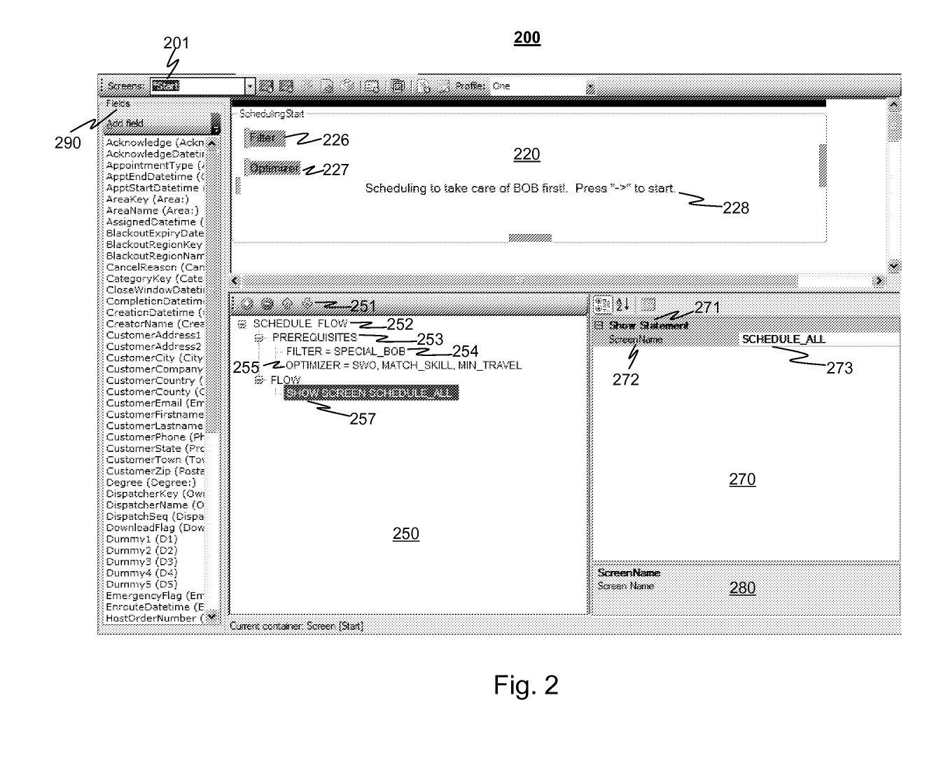

FIG. 2 illustrates the components in the scheduling system's GUI configuration tool 200. The GUI tool 200 provides a screen with a screen area for a Screen Editor 220, a screen area that displays a Schedule Flow Editor 250, a screen area for a Context Sensitive Editor 270, and a screen area providing data fields that may be used in the creation of scheduling logic statements.

### Schedule Flow Editor

The Schedule Flow Editor 250 enables users to dynamically configure the scheduling logic of a Schedule Flow 252 by configuring one or more scheduling logic statements.

Scheduling logic statements may be constructed with functions, parameters, and options that include “If-Then-Else”, and “While” logic functions that are made available in Context Sensitive Editor 270. Context Sensitive Editor 270 provides the user with a menu of available functions, parameters and options to configure scheduling logic statements. Users may edit the scheduling logic by adding, editing, deleting and/or arranging the sequence of scheduling logic statements with toolbar options 251 provided in Schedule Flow Editor 250.

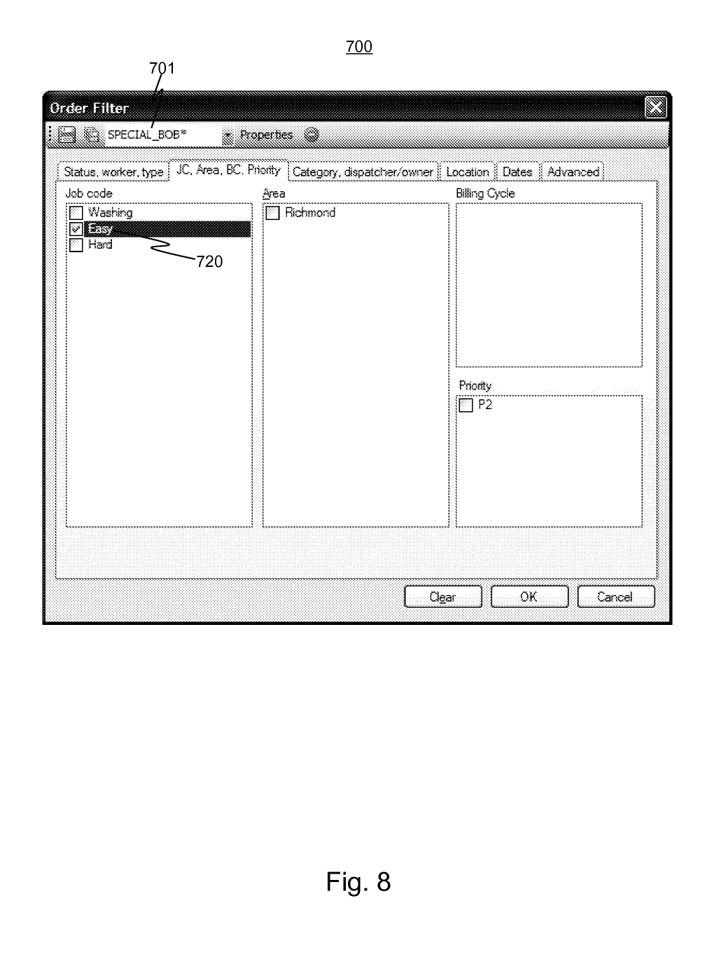

A Schedule Flow 252 may also be configured with one or a plurality of Prerequisites 253, which may include filters 254 and optimizers 255. Filters enable a user to focus scheduling functions by identifying sub-populations of scheduling populations for inclusion or exclusion according to user-definable criteria. The GUI tool provides a screen for configuring scheduling filters as illustrated in FIG. 7 and FIG. 8.

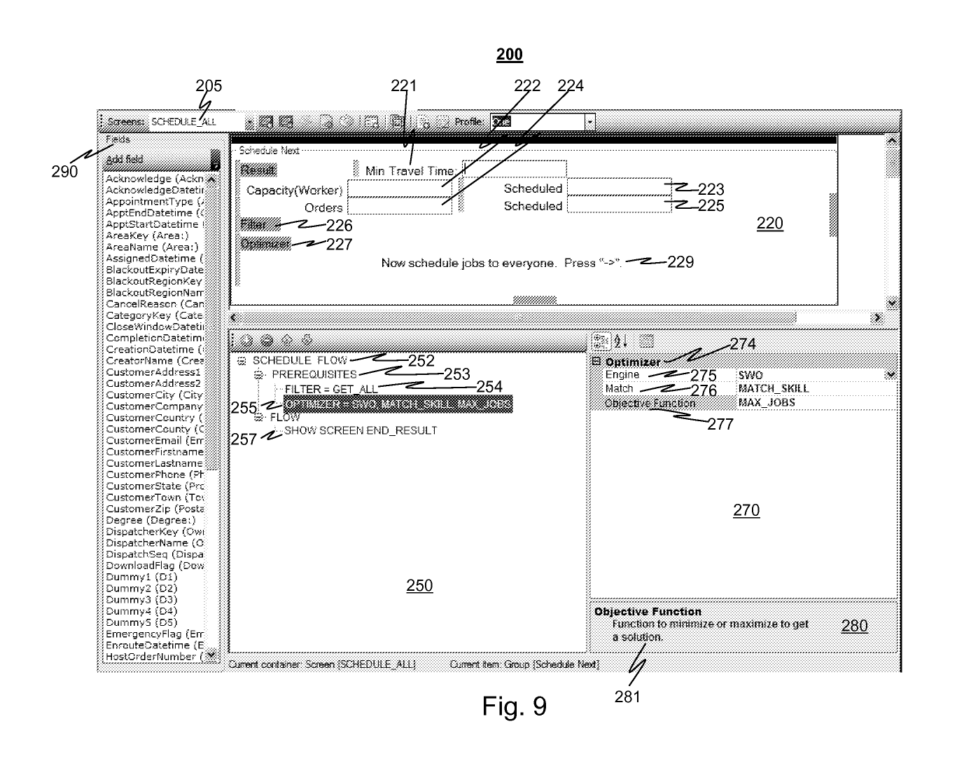

Schedule Flows 252 may employ Optimizers 255 to generate appropriate scheduling outcomes that satisfy specific matching functions and Objective Functions. Matching functions are methods and criteria applied to generate scheduling allocations that satisfy particular user defined matching criteria. Objective Functions are algorithms and methods applied to generate scheduling outcomes that sufficiently satisfy particular scheduling objectives, such as minimizing worker travel times, maximizing resource capacity, and minimizing labour costs. Users may configure the use of particular Optimizers 255 through Context Sensitive Editor 270. FIG. 9 shows that when a user selects the Optimizer element 255 in the Schedule Flow 252 the Context Sensitive Editor 270 displays a context sensitive menu 274 of available options including available scheduling engines in the “Engine” element 275, available matching functions in the “Match” element 276, and available Objective Functions in the “Objective Function” element 277. The user may further select an element within the Context Sensitive Editor 270 to view the available options for each element. A screen area 280 is provided to display a description of the element that is selected in Context Sensitive Editor 270. FIG. 9 shows that a description 281 is provided to describe an Objective Function when the Objective Function element 277 is selected in the Context Sensitive Editor 270. A fields menu 290 provides and enables users to create data fields and repeatable fields that may be selected and applied in the configuration of scheduling logic and user screens. “Repeatables” are data fields that are a combination of fields that tend to repeat many rows and are also referred to as tables in an HTML paradigm.

### Screen Editor

Each Schedule Flow 252 is associated with and executed by a user-defined user screen. User screens may be configured to display particular information and/or options to assist the processing of a particular Schedule Flow 252. Referring to FIG. 2, user screens may be configured in the Screen Editor 220 of the GUI tool 200.

A plurality of user screens may be employed within a Schedule Run to execute a plurality of Schedule Flows 252. User screens are linked and employed by the “Show Screen” function 257 within the scheduling logic of each Schedule Flow 252. When the user selects the “Show Screen” element 257 in the Schedule Flow 252 the Context Sensitive Editor 270 displays the available options for the “Show Statement” 271, which include available user screens through the “ScreenName” element 272. FIG. 2 shows the selection of a screen named “Schedule_All” 273 in the Context Sensitive Editor 270, which is then applied to the Schedule Flow logic statement “Show Screen Schedule_All” 257.

User screens may be configured to display particular aggregated results from the processing of Schedule Flows. FIG. 9 shows the use of the Screen Editor 220 to configure the “Schedule_All” user screen 205. The “Schedule_All” user screen 205 is configured to show particular aggregated results from the processing of the preceding Schedule Flow 252 that is illustrated in the “Start” screen 201 of FIG. 2.

The partitioning of the scheduling logic into a plurality of Schedule Flows 252 and the association of a user screen with each Schedule Flow 252, enables the user to identify the scheduling outcome of each Schedule Flow 252. Therefore, the system enables the user to accurately assess and edit Schedule Flow 252 elements in a complex Schedule Run to generate preferred scheduling outcomes.

### Flowchart Configuration

The GUI tool 200 enables users to configure a Schedule Run with scheduling logic according to intuitive methods that may be illustrated by a flowchart. Scheduling logic may be configured to satisfy particular scheduling parameters and conditions.

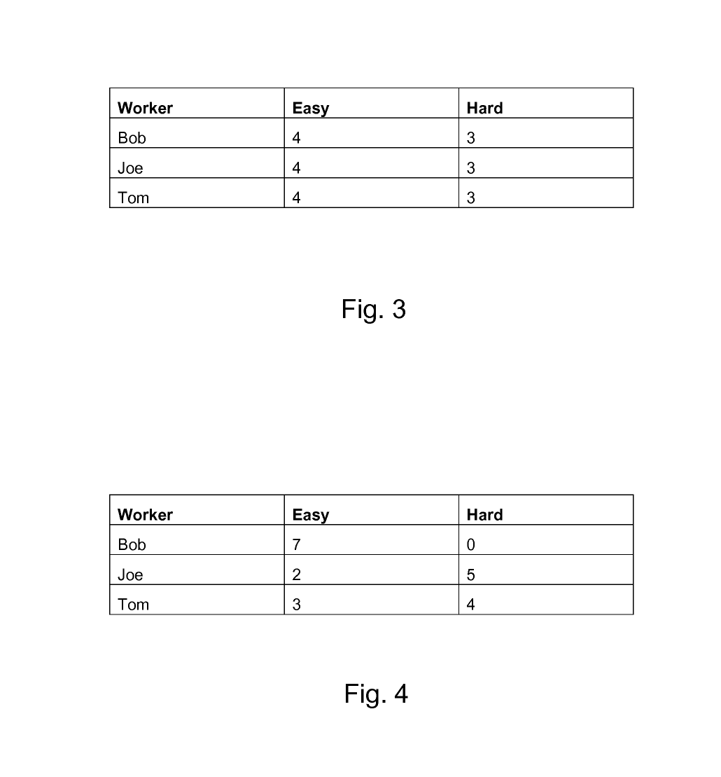

FIG. 3 shows an example of a schedule wherein a total of twenty-one jobs are allocated to three workers named Bob, Joe and Tom, respectively, for one workday. Each worker may be allocated with a maximum of seven jobs in a workday. All jobs require one hour to complete and are defined as either “easy” or “hard”. The schedule in FIG. 3 shows that all easy and hard jobs have been allocated among the three workers within their workday parameters.

An additional scheduling condition may be introduced that requires all “easy” jobs to be allocated to Bob prior to other workers. FIG. 4 illustrates a schedule that satisfies the additional scheduling condition by allocating “easy” jobs to Bob until his workday is full, and allocating the remaining “easy” jobs and “hard” jobs to Joe and Tom.

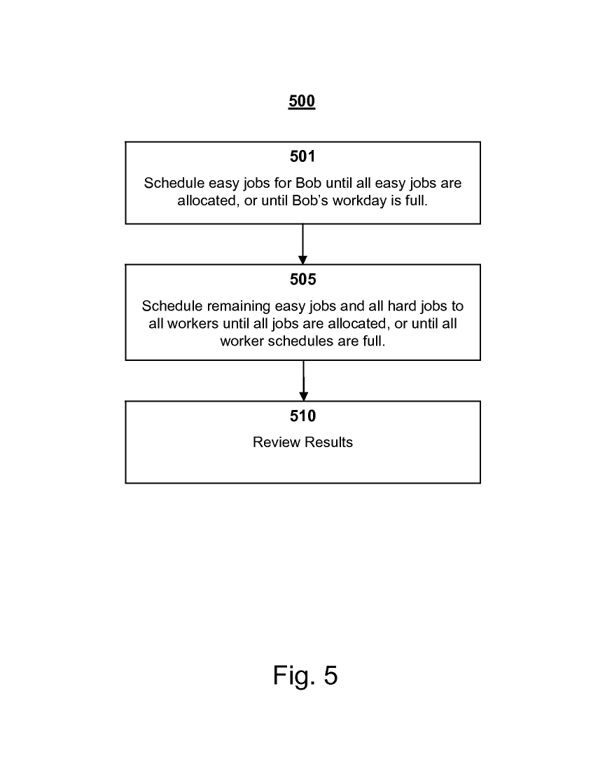

FIG. 5 shows a flowchart 500 that illustrates exemplary cognitive steps that may be applied to generate a schedule that satisfies the scheduling condition for Bob. The first step 501 allocates “easy” jobs to Bob until all “easy” jobs have been allocated, or until Bob's workday is filled. The second step 505 allocates any remaining “easy” jobs and all “hard” jobs to all three workers until all jobs have been allocated, or until all worker schedules have been filled. The resulting schedule may be reviewed in a final step 510.

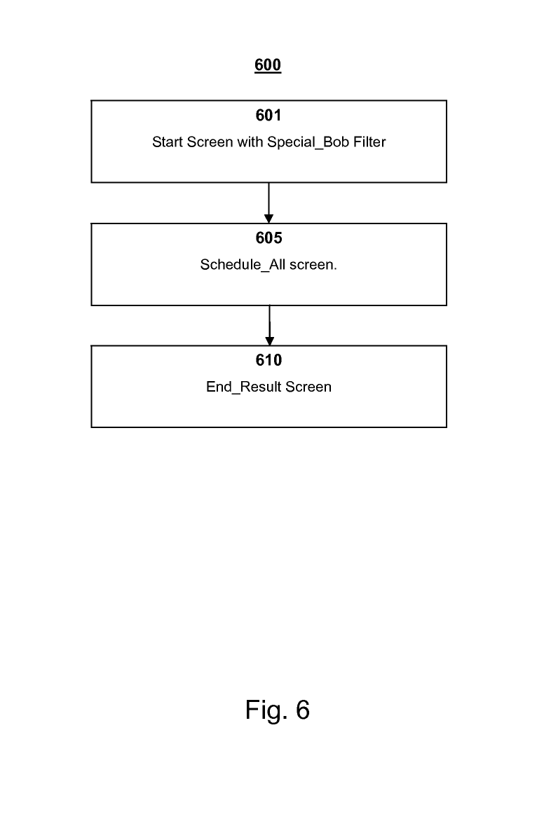

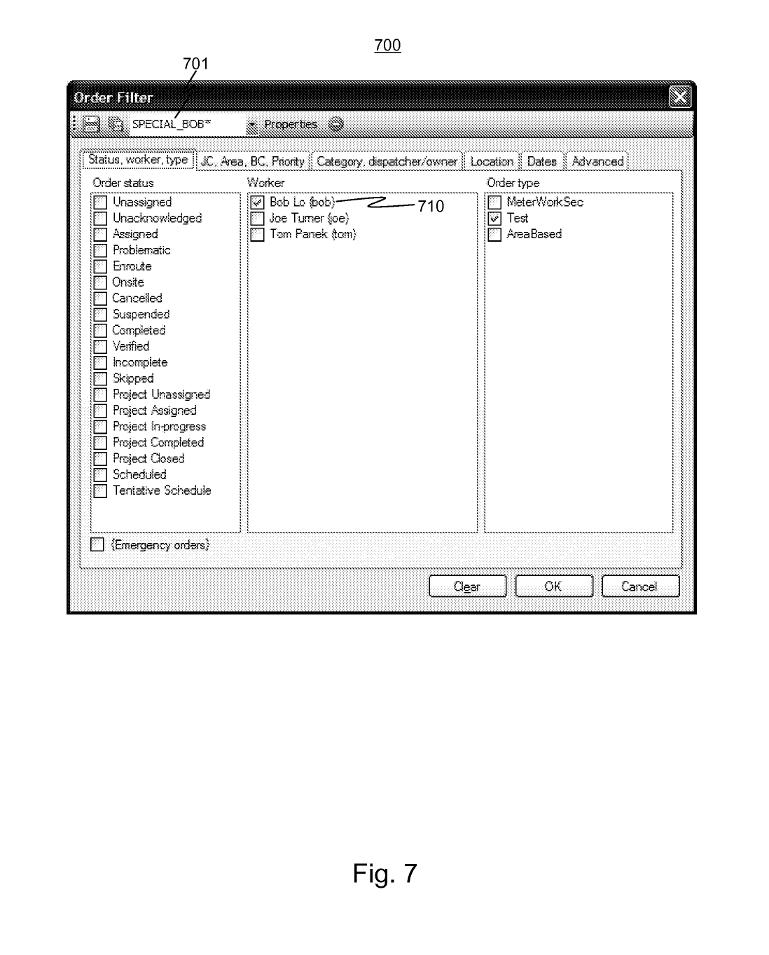

The GUI tool 200 enables a user to configure a Schedule Run with scheduling processes that accurately reflect the cognitive procedures that are described by the user-defined flowchart 500. FIG. 6 outlines a configuration of user screens that may be used to execute scheduling processes that reflect the steps defined in flowchart 500. A “Start” screen 601 is configured to execute the process of allocating “easy” jobs to Bob by employing a special filter that is configured to satisfy the scheduling needs for Bob. A second screen 605 is configured to execute the allocation of all remaining jobs to all three workers until all jobs have been allocated, or until all worker schedules have been filled. An “End_Result” screen 610 is configured to provide scheduling results for review.

### Filters

A filter may be created through Filter Editor 700 to isolate scheduling for the worker named “Bob” with jobs that are defined as “easy”. FIG. 7 and FIG. 8 show the use of the Filter Editor 700 to configure a filter that isolates the scheduling of “easy” jobs to Bob. FIG. 7 shows that the name “Bob” 710 is selected from a list of available worker names to isolate the specific worker for scheduling. FIG. 8 shows that the “Easy” job code 720 is selected from a list of available job codes to isolate the specific job type for scheduling. The filter is named “Special_Bob” 701 and is saved in the database 105 to be made available for use in a Schedule Flow 252. Additional attributes including Order Status, Order Type, Worker Type, and Area may also be used as filtering criteria.

Referring to FIG. 2, the “Special_Bob” filter is applied within the Prerequisites 253 element of the Schedule Flow 252. The user configures the use of the “Special_Bob” filter in the Schedule Flow 252 by selecting the “Filter” element 254 and selecting the “Special_Bob” filter from a menu of available filters that may be displayed in the Context Sensitive Editor 270.

The Schedule Flow 252 of FIG. 2 also shows the configuration of Optimizer elements 255 that include the use of a Squeaky Wheel Optimizer (SWO), a matching function named “MATCH_SKILL”, and an Objective Function for minimizing travel time named “MIN_TRAVEL”.

A user screen that enables end users to execute the Schedule Flow is defined in the GUI tool 200′s Screen Editor 220. The screen is named “Start” 201 and is configured to display the message “Scheduling to take care of Bob first! Press ‘->’ to start” 228. The Schedule Flow 252 is executed when end users select the defined graphic icon “->” on the user screen. Each Schedule Flow 252 is effectively associated with a user-defined screen that is displayed to end users prior to the execution of the Schedule Flow 252.

The Schedule Flow 252 employs a “Show Screen” function 257 that is configured to show the “Schedule_All” screen after executing the functions defined in the Schedule Flow 252 for the “Start” screen 201.

FIG. 9 shows the use of GUI tool 200 to configure the screen definitions for the “Schedule All” screen 205 and the associated Schedule Flow 252. The “Schedule_All” user screen 205 is configured through the Screen Editor 220 to display particular aggregate values that are generated from the execution of the Schedule Flow 252 associated with the “Start” screen 201 in FIG. 2. The screen provides particular aggregate values to enable an end user to assess the progress of the scheduling process and the effectiveness of the previously executed Schedule Flow 252 configuration. Aggregate values include minimum travel time involved (“Min. Travel Time” 221), the total worker capacity that is available for scheduling (“Capacity (Worker)” 222), the amount of worker capacity that is scheduled (“Scheduled” 223), the amount of orders that require scheduling (“Orders 224), and the amount of orders that are scheduled (“Scheduled” 225).

The “Schedule_All” screen 205 is configured to provide users with the Filter 226 and Optimizer 227 elements. End users may select the Filter 226 and/or Optimizer 227 elements to view, apply and/or override the Filter and/or Optimizer configurations. A message “Now schedule jobs to everyone. Press ‘->’.” 229 is configured for display on the “Schedule_All” screen 205.

The Schedule Flow 252 associated with the “Schedule_All” screen 205 is configured with Prerequisites 253 that apply a filter named “Get_All” 254, which is configured to schedule all jobs to all workers. The Optimizer elements 255 are configured to employ a Squeaky Wheel Optimization (SWO) scheduling engine, a “Match_Skill” matching function, and a “Max_Jobs” Objective Function.

The Schedule Flow 252 employs a “Show Screen” function 257 that is configured to show the “End_Result” screen after executing the functions defined in the Schedule Flow 252 for the “Schedule_All” screen 205.

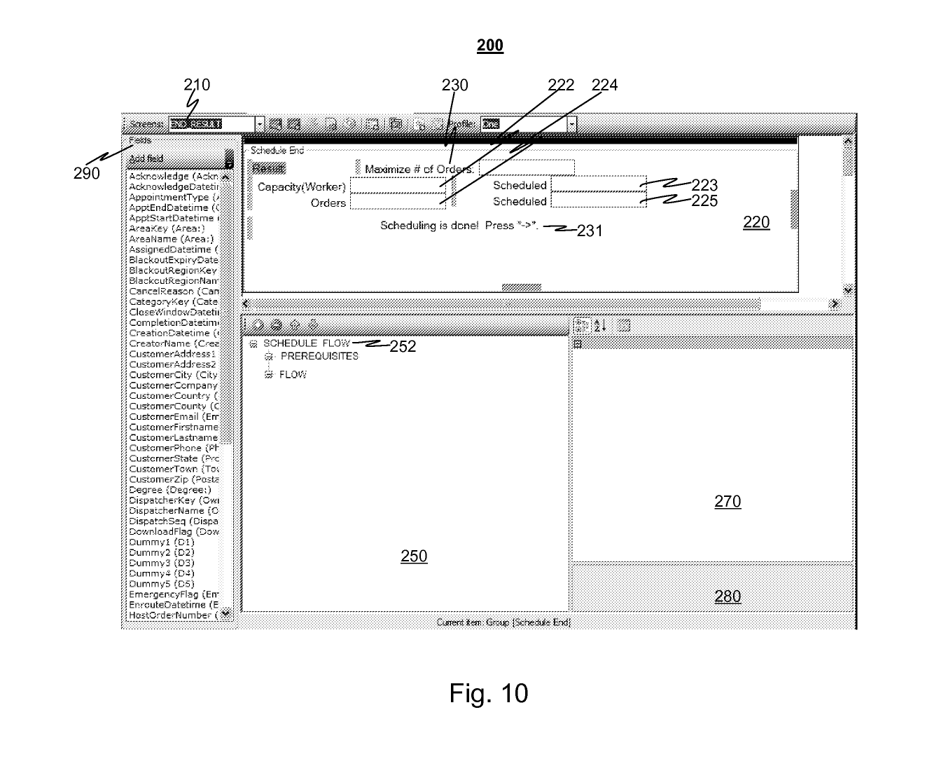

FIG. 10 shows the configuration of the “End_Result” screen 210 in the Screen Editor 220. The “End_Result” screen 210 is configured to display particular aggregate values that include maximize numbers of orders (“Maximize # of Orders” 230), the total worker capacity that is available for scheduling (“Capacity (Worker)” 222), amount of worker capacity that is scheduled (“Scheduled” 223), the amount of orders that require scheduling (“Orders” 224), and the amount of orders that are scheduled (“Scheduled” 225). The aggregate values represent the outcomes that are generated from the execution of the Schedule Flow 252 associated with the “Schedule_All” screen 205 in FIG. 9. The “End_Result” screen 210 is also configured to display the message “Scheduling is done! Press ‘->’.” 231.

The Schedule Flow 252 of the “End_Result” screen 210 is intentionally left blank in the Schedule Flow Editor 250 to end the scheduling process.

The user screen definitions, scheduling logic, and Prerequisites configurations of a Schedule Run may be saved and stored in the database 105 for use when called by an end user. The Schedule Run configuration and procedures that include the “Special_Bob” filter, “Start” screen, “Schedule_All” screen and “End_Result” screen, effectively provide a one-to-one mapping of the cognitive procedures defined by flowchart 500 in FIG. 5.

Implementing the Schedule Run through User Screens

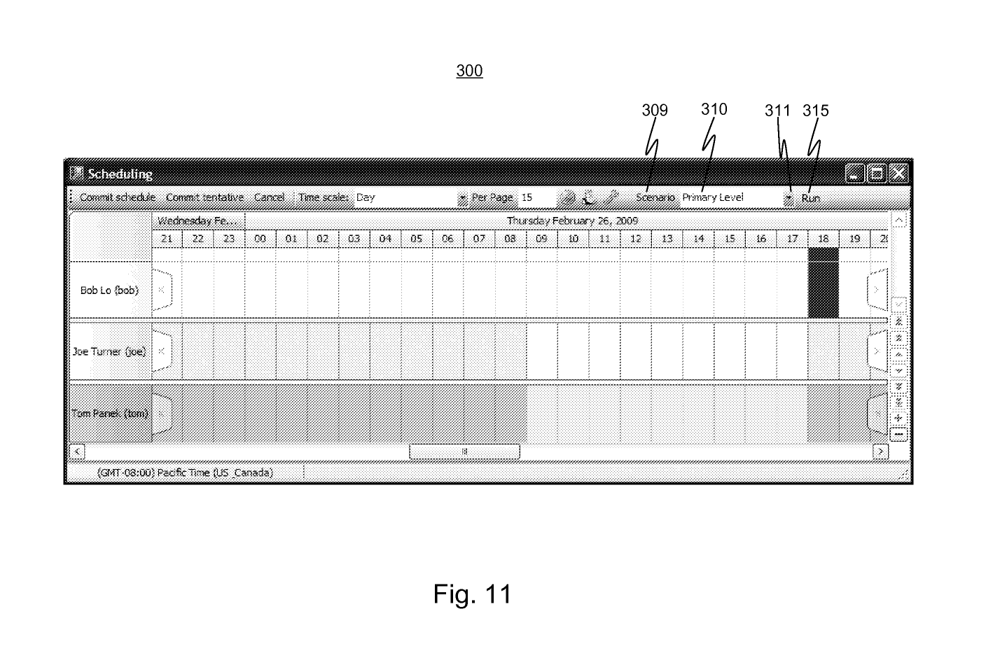

The Schedule Run may be initiated by an end user through the system's Scheduling Sandbox tool 300 which may also be referred to herein simply as the Sandbox tool 300. FIG. 11 illustrates the system's Sandbox tool 300. The Sandbox tool 300 displays a schedule of allocated jobs for a list of workers from the processing of Schedule Runs. Prior to performing a Schedule Run, the Sandbox tool 300 shows that the workers have not been allocated with any jobs.

The user may generate a schedule by selecting a particular user configured Schedule Run from a drop down menu 311 of Scenarios. Schedule Runs are also referred to herein as Scheduling Scenarios or simply Scenarios 309. FIG. 11 shows the selection of a Scenario called “Primary Level” 310. The toolbar's “Run” button 315 is then selected to initiate the selected Schedule Run.

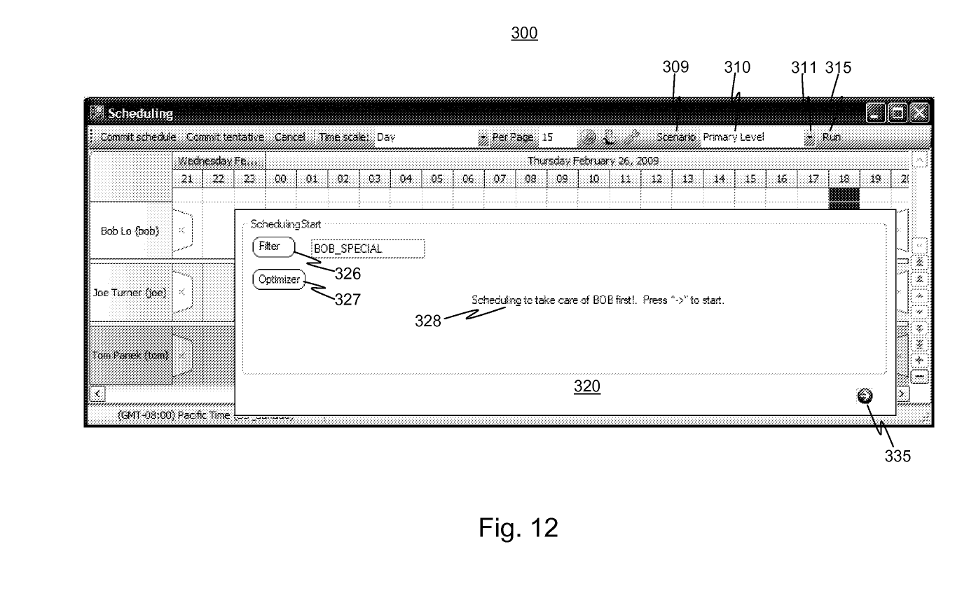

FIG. 12 shows the user screen 320 definitions configured through the Screen Editor 220 shown in FIG. 2, including the message “Scheduling to take care of BOB first! Press “->” to start.” 328. The user may view and override the configuration of the Filter 326 element, which shows the application of the “Bob_Special” filter, and the Optimizer 327 elements by selecting the buttons provided, or choose the specified graphic icon 335 to execute the associated Schedule Flow 252.

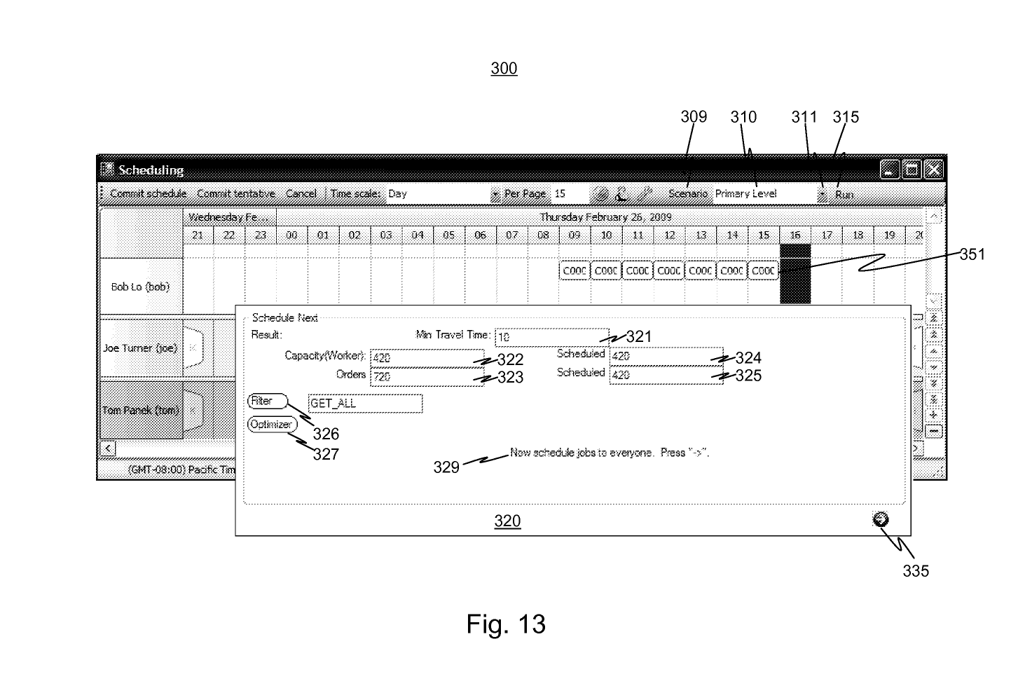

Referring to FIG. 13, the Sandbox tool 300 shows the allocation of “easy” jobs 351 to Bob's schedule 351 from running the Schedule Flow 252 that is executed from the previous “Start” screen. The user screen 320 displays the “Schedule_All” definitions configured in the Screen Editor 220 shown in FIG. 9. The user screen 320 is configured to display aggregate values that represent particular results from the processing of previous Schedule Flows 252. The aggregate values show that the minimum travel time involved is 10 minutes in the field (“Min. Travel Time” 321), the worker capacity in terms of minutes is 420 (“Capacity (Worker)” 322), the amount of worker capacity that is scheduled is 420 minutes (“Scheduled” 324), orders required for scheduling in terms of minutes is 720 (“Orders” 323), and the amount of orders that are scheduled is 420 minutes (“Scheduled” 325).

After reviewing the aggregated values the user may choose to modify the configuration of the Filter 326 and/or Optimizer 327 elements by selecting the buttons provided, or choose the specified graphic icon 335 to process the next Schedule Flow 252 within the Schedule Run.

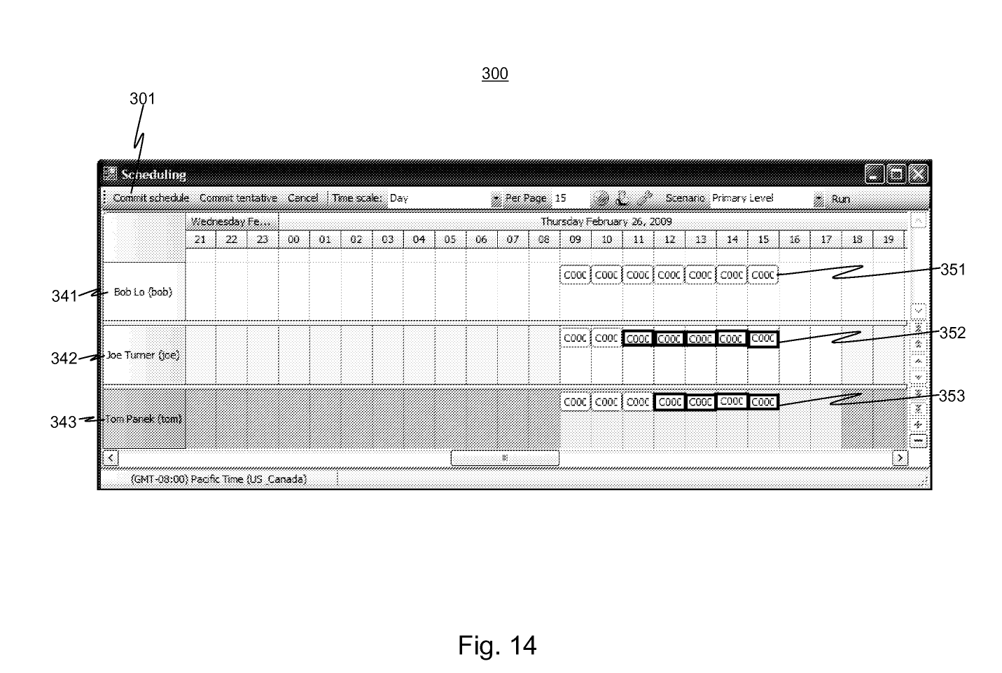

Referring to FIG. 14 the Sandbox tool 300 displays the allocation of jobs to workers that reflects the allocation schedule of FIG. 4. The worker “Bob” 341 is allocated with seven “easy” jobs 351, the worker “Joe” 342 is scheduled with two “easy” jobs and five “hard” jobs 352, and the worker “Tom” 343 is scheduled with three “easy” jobs and four “hard” jobs 353. “Hard” jobs are identified with a bold border. The user may select the “Commit Schedule” option 301 to accept the results of the Schedule Run.

### Partitioning of Scheduling Logic

The system's GUI configuration tool 200 enables the user to create and configure a plurality of screens where each screen performs specific scheduling logic of a Schedule Flow 252. By enabling the user to employ a plurality of screens to represent specific scheduling logic, a user may identify and understand the particular scheduling outcomes from the application of the scheduling logic. Therefore, the user may identify and edit relevant scheduling logic to generate preferable scheduling outcomes.

The method of representing particular scheduling logic of a Schedule Run with separate screens allows the partitioning of the screens and the scheduling logic. The partitioning of the screens reduces the complexity of the logic, and greatly reduces the memory and processing requirements.

### Batch Mode

Schedule Runs may also be run in batch mode without user interaction. A system task may be configured to invoke a Schedule Run based on a time or the occurrence of other user defined events. When a Schedule Run is performed in batch mode, a screen presentation is written for each Schedule Flow 252 to the database and logged. The Schedule Run proceeds to the next Schedule Flow 252 and continues until all Schedule Flows 252 have been run. The run log can be subsequently viewed by a user to analyze the results that are recorded according to user-defined screen definitions. The system may be designed to automatically commit the results of batch processing to a schedule.

### Schedule_Type

The GUI configuration tool 200 organizes the information for each Schedule Run as an object that is referred to herein as a Schedule_Type. A Schedule_Type defines a Schedule Run with the definitions for each Schedule Flow, including each user screen, and the corresponding data fields, and the scheduling logic.

The GUI configuration tool 200 integrates the Schedule_Type user screen definitions and scheduling logic as executable constructs that are made available to the application software. New and/or edited Schedule_Type definitions are interpreted by the application, without requiring the re-writing or re-compiling of the application software and without interrupting the operability of the application at any time.

The system integrates Schedule Flow logic using programming language based on Extensible Markup Language (XML), which provides programming constructs such as variables, conditions, operations, loops and custom actions and allows users to employ variables and global variables to assist in the logic. The language is loaded as an XML document when the user uploads changes to the database.

The system may use Document Object Model (DOM) methods to traverse the Schedule Flow logic. The system uses the DOM to execute the XML instructions as defined by the logic.

A common project is written once and compiled for either desktop or server consumption. The common project then reads the XML definition for the document and allows the clients to utilize the document and Schedule Flow. An application program de-serializes the XML code into objects that know how to logically evaluate the XML command nodes. The application loads the relevant document files at start up and reloads updated files when notified.

In an example embodiment the system uses a build process that takes the GUI configuration tool 200 output, and compiles and links the modules. The GUI configuration tool 200 output feeds an upload process into the database schema. The process builds and uploads multiple Schedule_Types.

The Internal Build tool and database schema deals with both pre-defined or business rule fields, as well as user-defined fields, specific to each user-defined Schedule_Type.

A tool such as a Structured Query Language (SQL) Server, or Oracle™ database's Extensible Markup Language (XML) component is used to define and encapsulate the customer-defined fields as a single large XML data string within one field of database 105. This method hides the complexity and variability of these fields.

This approach allows the user-defined Schedule_Type to effectively be decoupled from the build process, greatly simplifying the build process and database upload process.

An XML query language, such as XQuery, that can use the structure of XML to express queries across all kinds of data stored or expressed as XML, is used to extract and process the user-defined fields in an efficient manner from database 105.

The build process uses XML data to decouple the Schedule_Type and hide the complexity of the user-defined fields from the build process. This provides a reliable and efficient build process that prevents overly complex builds.

### Second Example for Extensibility

The system according to then invention allows users to employ extensible code to satisfy scheduling needs that may not be readily accommodated by the predefined functions and options of the system.

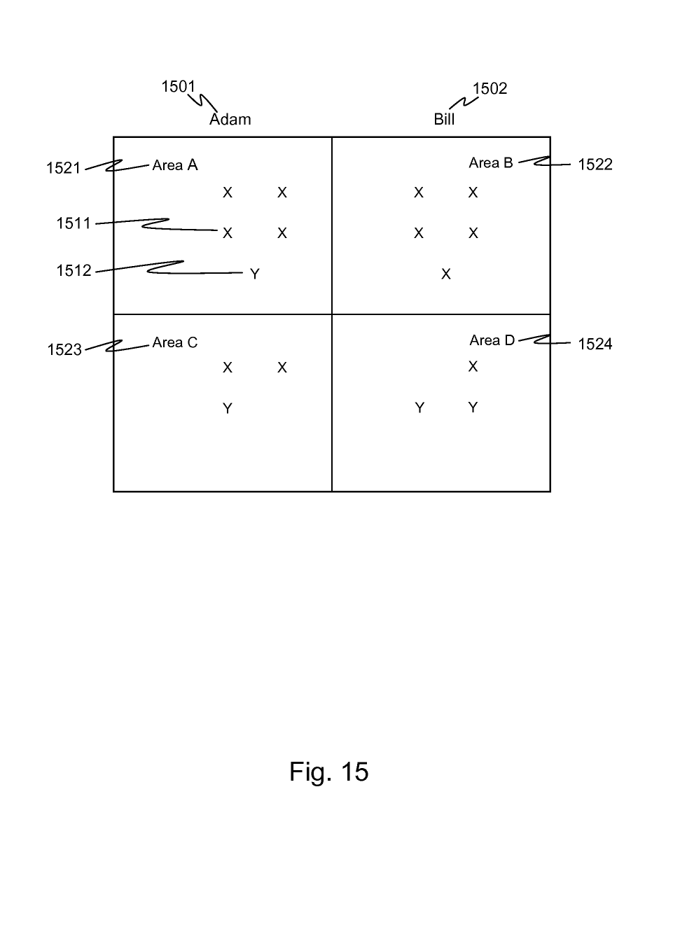

The need for extensible functions is illustrated by an example in which the system is required to schedule a plurality of job types to a plurality of workers, and each worker is associated with a plurality of different work areas in accordance to specific preferences. The scenario includes two workers who each have a primary work area and a secondary work area. FIG. 15 illustrates the work areas for the two workers named “Adam” 1501 and “Bill” 1502. Adam's primary work area is “Area A” 1521, and his secondary work area is “Area C” 1523. Bill's primary work area is “Area B” 1522, and his secondary work area is “Area D” 1524.

Two different job types defined as “X” 1511 and “Y” 1512 are located within the four worker areas. Each worker has a job capacity to perform six X jobs and two Y jobs per day.

A scheduling preference governs the appropriate allocation of jobs based on the location of each job within the four worker areas. Jobs that are outside of a worker's primary and secondary areas are allocated to a worker only when an insufficient number of jobs are located within the worker's primary and secondary work areas to fill the worker's job capacity. Adam's “Other” work area include “Area D” 1524. Bill's “Other” work area include “Area C” 1523.

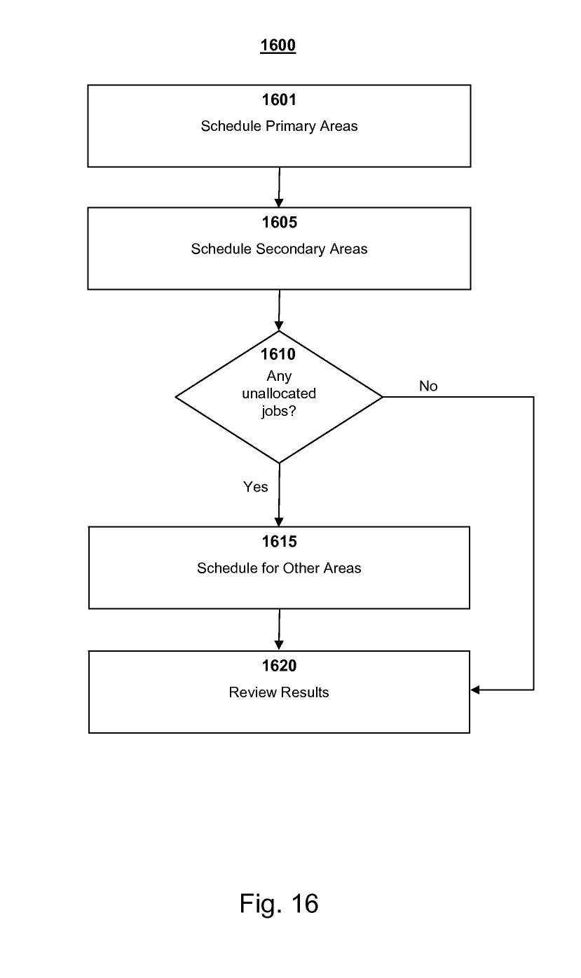

FIG. 16 illustrates a flowchart 1600 that outlines the procedures for allocating jobs to workers in accordance to the job type and work area preferences. The first step 1601 involves scheduling jobs to workers' primary areas. The second step 1605 involves scheduling jobs to workers' secondary areas. At step 1610, decision logic is applied to determine if any jobs are unallocated. If unallocated jobs are identified, at step 1615, jobs will be scheduled to the workers' “Other” areas. The scheduling results will then be displayed for review at step 1620. If the decision logic does not identify any unallocated jobs the scheduling results will be displayed for review at step 1620.

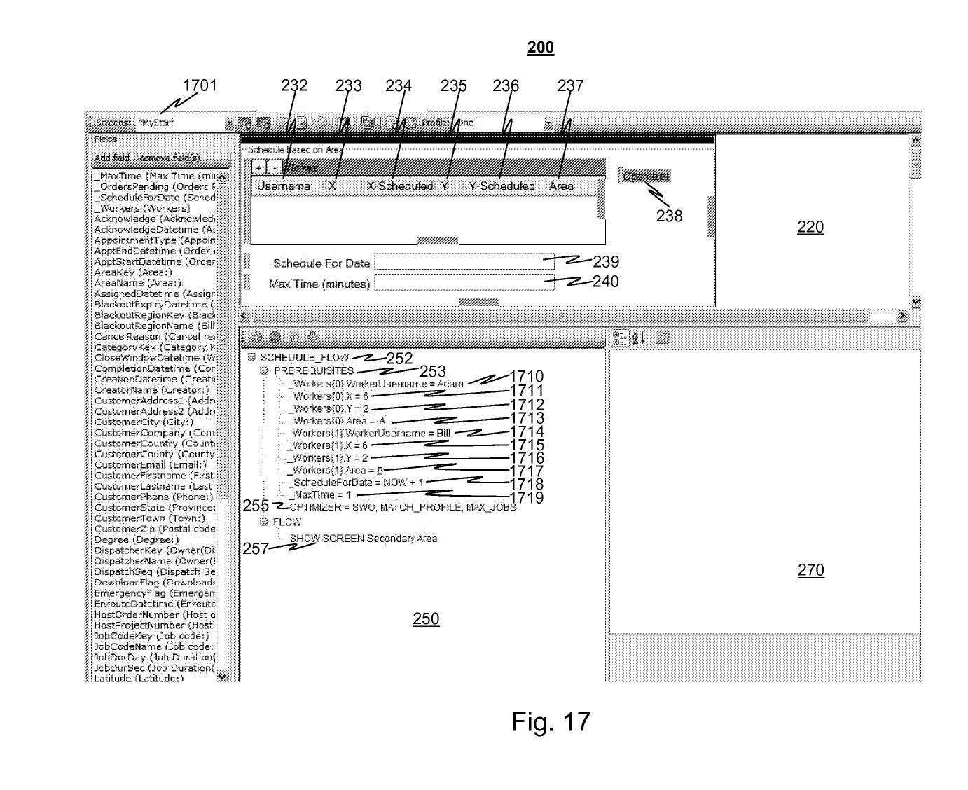

FIG. 17 through FIG. 20 show the use of the GUI tool 200 to configure the user screens and scheduling logic that represent a one-to-one mapping of the intuitive scheduling processes illustrated by flowchart 1600, and which satisfy the conditions of the scheduling scenario.

In an example of an embodiment of the invention the scheduling system may not have predefined methods for scheduling a plurality of different work areas for a plurality of workers. The system architecture can readily accommodate the unanticipated needs of the scheduling scenario by allowing a user to create appropriate data fields with the GUI tool 200 and incorporate custom functions with extensible code. To accommodate the particular data of the scheduling scenario the user may use the GUI tool 200 to create repeatable fields that hold the relevant data for each worker.

The GUI tool 200 is used to configure a Schedule Run with a user screen named “MyStart” 1701 to allocate jobs to workers' primary areas; a user screen named “Secondary Area” 1801 to allocate jobs to workers' secondary areas; and a user screen named “Other Area” 1901 to allocate jobs that are outside of the workers' primary and secondary areas if necessary.

FIG. 17 shows the configuration of the “MyStart” screen 1701 in the GUI tool 200′s Screen Editor 220. The “MyStart” screen 220 is configured to display scheduling data that include the worker names under “Username” 232, type “X” jobs that require scheduling 233, type “X” jobs that are scheduled 234, type “Y” jobs that require scheduling 235, type “Y” jobs that are scheduled 236, and the areas in which jobs are scheduled 237. Fields are also configured to enable a user to define and override Optimizer elements 238, the assignment date of the schedule 239, and the maximum time allowed to run scheduling optimization 240.

Within the Schedule Flow 252 the Prerequisites element 253 is configured to apply a user created repeatable field named “_Workers” that includes a plurality of items that define the job capacity and worker area profile for each worker.

The repeatable field contains the item “_Workers(0).WorkerUsername=Adam” 1710 which defines items within the repeatable field that are named with “_Workers(0)” to be identified with the worker named “Adam”.

The item “_Workers(0).X=6” 1711 defines Adam's job capacity for performing “X” type jobs as six per day.

The item “_Workers(0).Y=2” 1712 defines Adam's job capacity for performing “Y” type jobs as two per day.

The item “_Workers(0).Area=A” 1713 defines the applicable work area condition for scheduling jobs to Adam as “A”.

The item “_Workers(1).WorkerUsername=Bill” 1714 defines items within the repeatable field that are named with “_Workers(1)” to be identified with the worker named “Bill”.

The item “_Workers(1).X=6” 1715 defines Bill's job capacity for performing “X” type jobs as six per day.

The item “_Workers(1).Y=2” 1716 defines Bill's job capacity for performing “Y” type jobs as two per day.

The item “_Workers(1).Area=B” 1717 defines the applicable work area condition for scheduling jobs to Bill as “B”.

The effective date for scheduling is defined in the item “_ScheduleForDate” 1718, which is configured for the following day by applying the statement “Now+1”.

The item “_MaxTime” 1719 defines the maximum time (measured in terms of minutes) that is allowed for the scheduling optimization to run. The value in the example is defined as 1 minute. The system may calculate and evaluate a multitude of scheduling options to determine and produce a schedule that optimally satisfies the user defined scheduling parameters and objectives. The time required to produce an optimum schedule is unknown before hand, and may be extensive when a scheduling scenario must match a plurality of large populations according to numerous parameters. The system may employ an Exit Method to govern the appropriate cessation of further scheduling optimization when particular conditions are met. The Exit Method may process the “_MaxTime” value as a condition to cease further scheduling optimization.

The Optimizer elements 255 are configured to employ a Squeaky Wheel Optimization (SWO) scheduling engine, a “Match_Profile” matching function, and a “Max_Jobs” Objective Function. The “Match_Profile” is a custom matching function that appropriately matches jobs according to their specific job type within the appropriate worker areas for each worker. Scheduling engines, matching functions and Objective Functions may be created by third party developers as extensible code that is integrated into the scheduling application through a published interface.

Matching functions may be created to perform “one-to-many” scheduling where a particular scheduling item, such as a complex work order, may be appropriately assigned with a plurality of scheduling items, such as a plurality of resources and/or a plurality of workers.

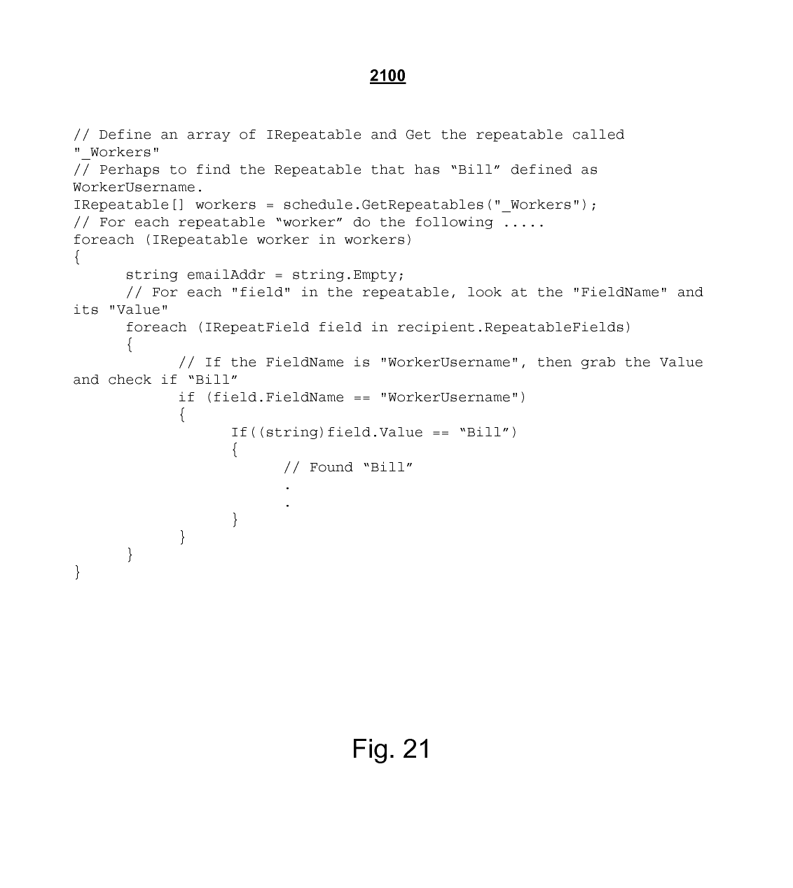

FIG. 21 shows an example of code 2100 for an interface that allows extensible code to access data fields in the database to perform custom functions. Extensible code may be created and stored as a Dynamic Link Library (DLL) within a specified folder stored in a database in server 101. Extensible codes are created and stored independently of the main code stream. The system uses Schedule Flows to call the use of DLLs.

Extensible code may use interfaces such as GetValue(NameOfField), GetRepeatable(NameOfRepeatable), foreach(IRepeatable), FieldName and SetValue to access and set values in data fields that are defined in a Schedule_Type.

Providing the use of sustained published interfaces allows both the extensible code and the main code stream to be independently upgraded or modified and to remain mutually compatible. Therefore, customer specific functions and features that are created as custom code do not need to be rewritten when upgrades or modifications are made to the system's software.

The “Show Screen” function 257 within the scheduling logic illustrated in FIG. 17 is configured to display the “Secondary Area” user screen after executing the Schedule Flow.

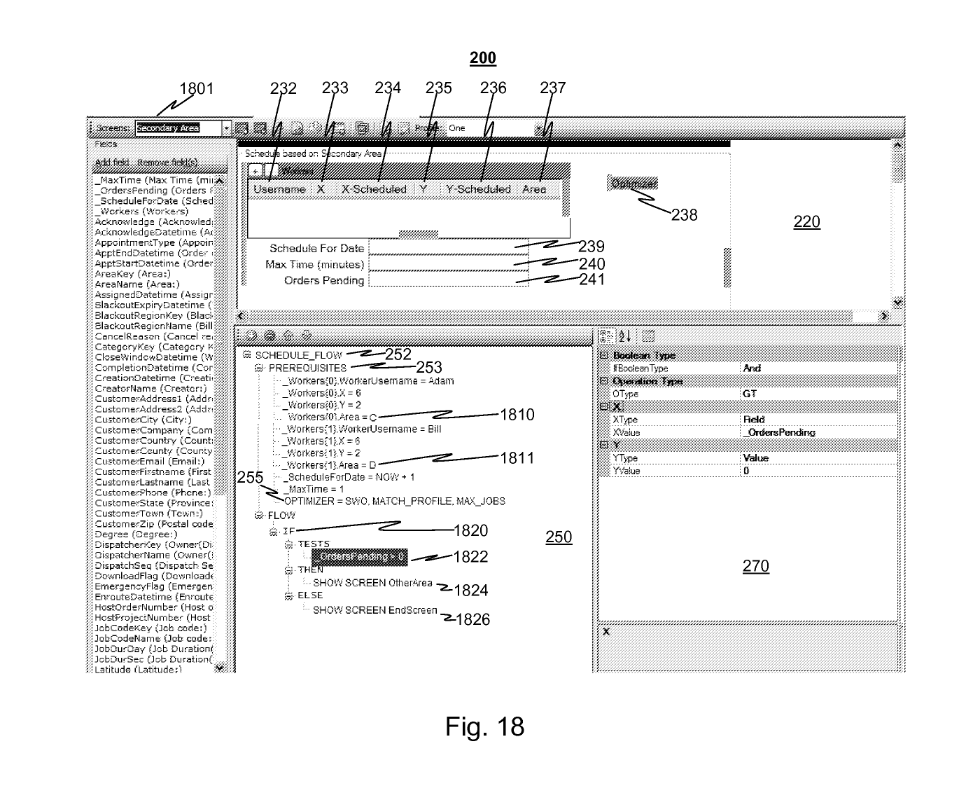

FIG. 18 shows the configuration of the “Secondary Area” screen 1801 and the scheduling logic for allocating jobs that are within each worker's secondary work area.

The configuration of the “Secondary Area” user screen is shown in the GUI tool 200′s Screen Editor 220. The “Secondary Area” user screen is configured to display scheduling data that include the worker names under “Username” 232, type “X” jobs that require scheduling 233, type “X” jobs that are scheduled 234, type “Y” jobs that require scheduling 235, type “Y” jobs that are scheduled 236, and the areas in which jobs are scheduled 237. Fields are also configured to enable a user to define and override Optimizer elements 238, the assignment date of the schedule 239, and the maximum time allowed to run scheduling optimization 240. The number of orders that remain unscheduled in “Orders Pending” 241 is also provided.

To schedule jobs within each worker's secondary area the user defines the applicable work areas for each worker in the relevant items of the “_Workers” repeatable field.

The item “_Workers(0).Area=C” 1810 defines Area C as the applicable work area for scheduling jobs to Adam.

The item “_Workers(1).Area=D” 1811 defines Area D as the applicable work area for scheduling jobs to Bill.

The scheduling logic is configured with an “If-Then-Else” construct 1820 that enables a user to configure the execution of appropriate functions according to user defined logic. The Schedule Flow 252 is configured to employ the “If-Then-Else” logic 1820 after completing the scheduling of jobs in the workers' secondary areas according to the configuration of the Prerequisites 253. The “If-Then-Else” construct 1820 includes a “Test” function that executes a condition named “_OrdersPending>0” 1822 which is stored in memory in server 101. The “_OrdersPending>0” test condition acts to identify any unallocated job orders after completing the scheduling of jobs within each worker's primary and secondary work areas.

If the test condition “_OrdersPending>0” 1822 identifies the presence of unallocated job orders, the scheduling logic will execute the “Show Screen Other Area” logic statement 1824 to display the “Other Area” user screen. If unallocated job orders are not identified the scheduling logic will execute the “Show Screen EndScreen” logic statement 1826 to display the “EndScreen” user screen.

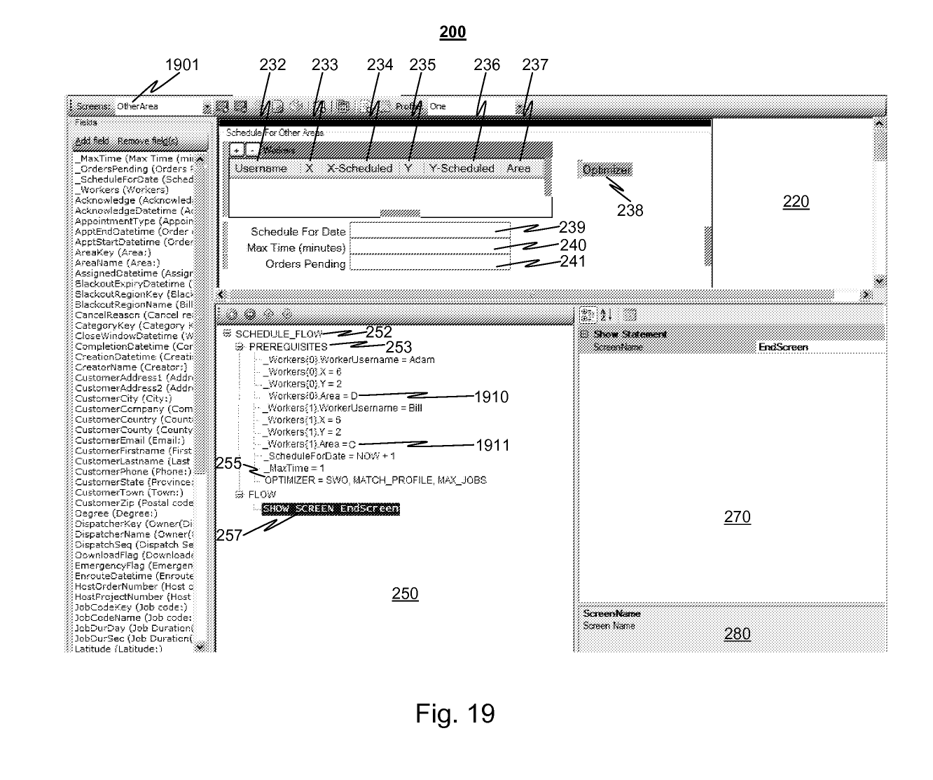

FIG. 19 shows the configuration of the “Other Area” screen 1901 and the scheduling logic for allocating jobs that are within each worker's “Other” areas. To schedule jobs that are outside of each worker's primary and secondary area, the user defines the applicable worker areas in the appropriate items within the Prerequisites 253. Adam's “Other” area is defined as Area D within the item “_Workers(0).Area=D” 1910. Bill's “Other” area is defined as Area C within the item “_Workers(1).Area=C” 1911. The scheduling logic is configured with a Show Screen function 257 to show the “EndScreen” user screen after executing the Schedule Flow.

The “Other Area” user screen is configured to display scheduling data that include the worker names under “Username” 232, type “X” jobs that require scheduling 233, type “X” jobs that are scheduled 234, type “Y” jobs that require scheduling 235, type “Y” jobs that are scheduled 236, and the areas in which jobs are scheduled 237. Fields are also configured to enable a user to define and override Optimizer elements 238, the assignment date of the schedule 239, the maximum time allowed to run scheduling optimization 240, and view the number of orders that remain unscheduled in “Orders Pending” 241.

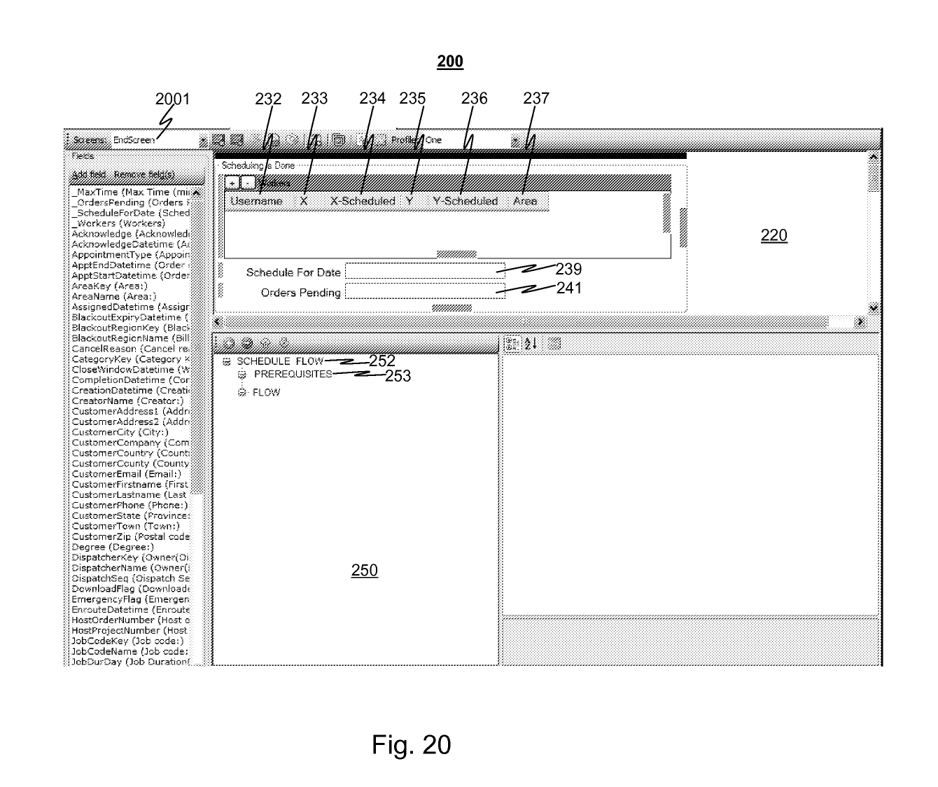

FIG. 20 shows the configuration of the “EndScreen” 2001. The “EndScreen” user screen is configured to display scheduling data that include the worker names under “Username” 232, type “X” jobs that require scheduling 233, type “X” jobs that are scheduled 234, type “Y” jobs that require scheduling 235, type “Y” jobs that are scheduled 236, and the areas in which jobs are scheduled 237. Fields are also configured to enable a user to define the assignment date of the schedule 239, and view the number of orders that remain unscheduled in “Orders Pending” 241.

The Schedule Flow 252 of the “EndScreen” screen 2001 is intentionally left blank in the Schedule Flow Editor 250 to end the scheduling process.

### Sandbox Function

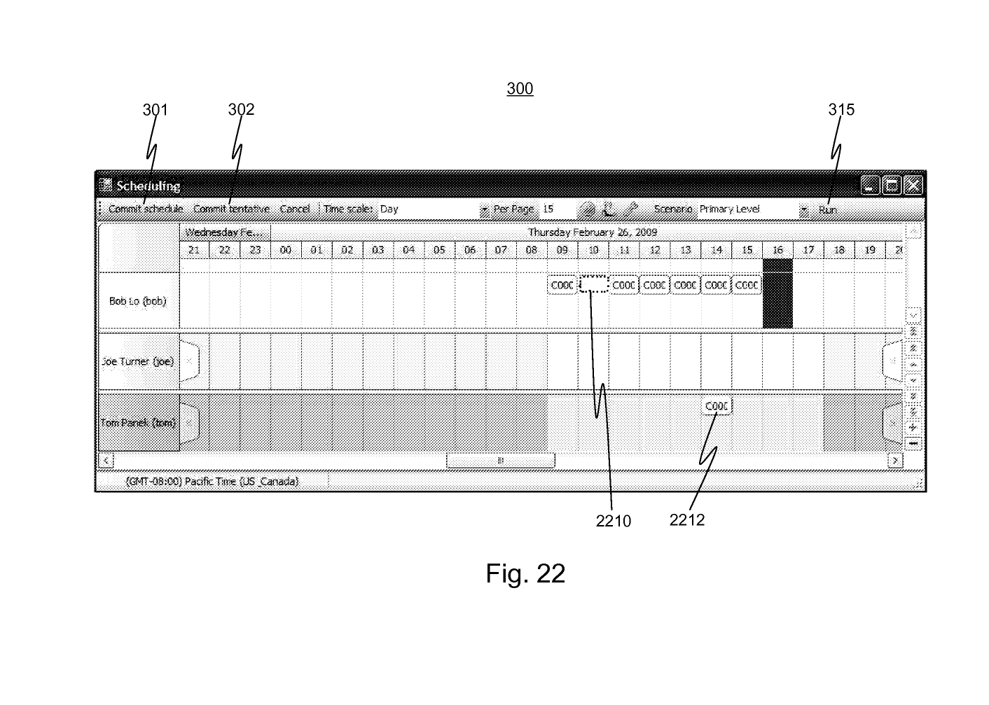

The scheduling system's “Sandbox” screen allows users to manually override any particular schedule item on a system generated schedule produced from the execution of each Schedule Flow 252 within a Schedule Run. FIG. 22 shows the modification of a system generated schedule through a user manually selecting and moving a particular scheduling item from one worker's schedule 2210 to another worker's schedule 2212. Modifications to the schedule will be forwarded to the server 101 when the user selects the specific graphic icon 335 on each user screen that may be presented to execute further Schedule Flows as illustrated in FIG. 13. After the completion of a Schedule Run the user may accept the system generated schedule by selecting the “Commit schedule” 301 option which forwards the schedule to the server 101. The user may also manually modify a proposed schedule that is generated from the completion of a Schedule Run, and apply the user modified schedule by selecting the “Commit schedule” 301 option.

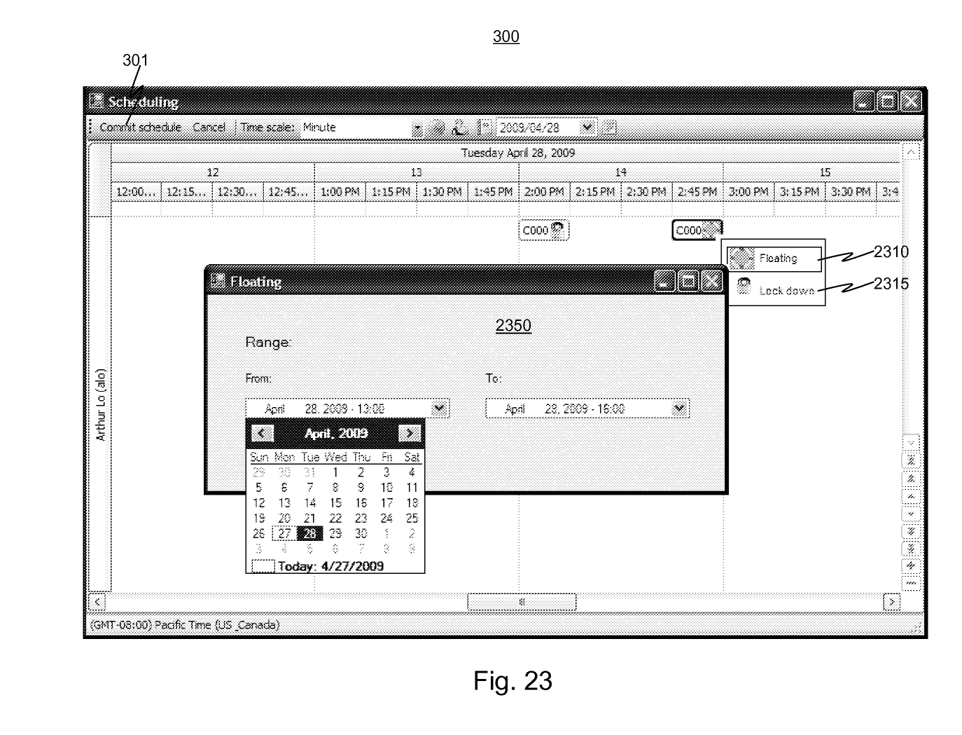

FIG. 23 shows that users may apply scheduling item options that are made available by double clicking on a schedule item with a pointing device, such as a mouse, to show options that include “Lock down” 2315 and “Floating” 2310. The user may apply a “Lock down” option 2315, which prevents changes to the specified scheduling item to occur from the additional processing of scheduling logic. The system may be defined to apply the “Lock down” option by default. Users may also apply a “Floating” 2310 option to specify a time interval that represents a time parameter in which a scheduling item may be reallocated to accommodate additional scheduling items. When selecting the Floating option 2310 a Floating sub-screen 2350 is made available to specify particular time and date parameters. Configurations to scheduling items will be forwarded to the server when the user selects the “->” button.

### Platform Architecture and Published Interfaces

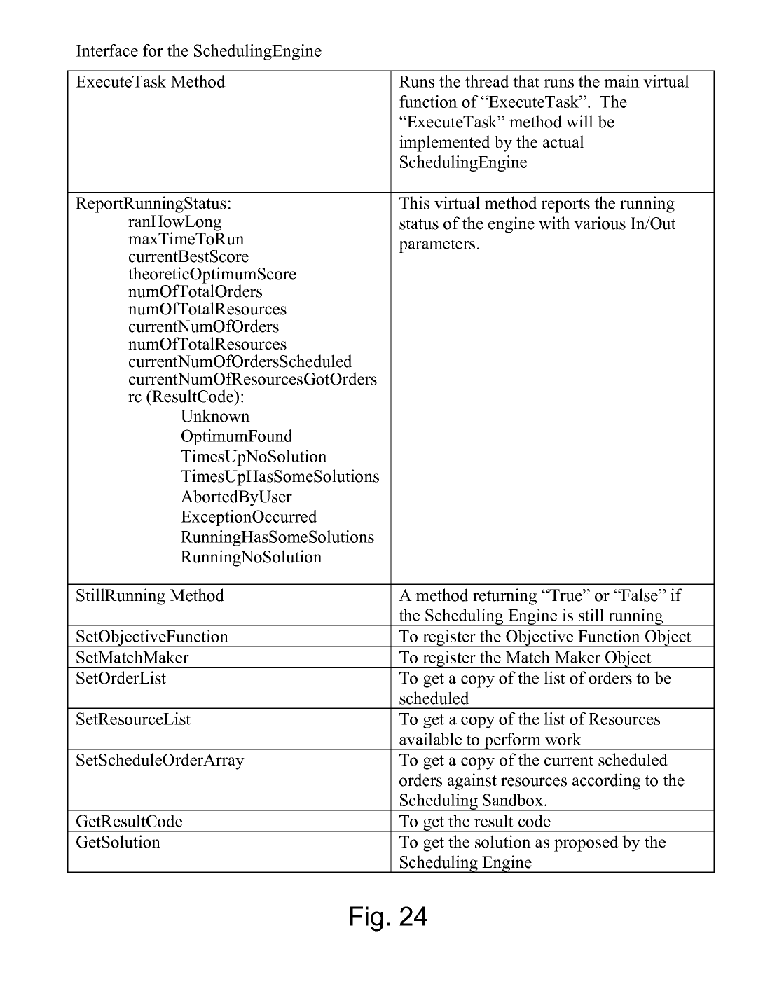

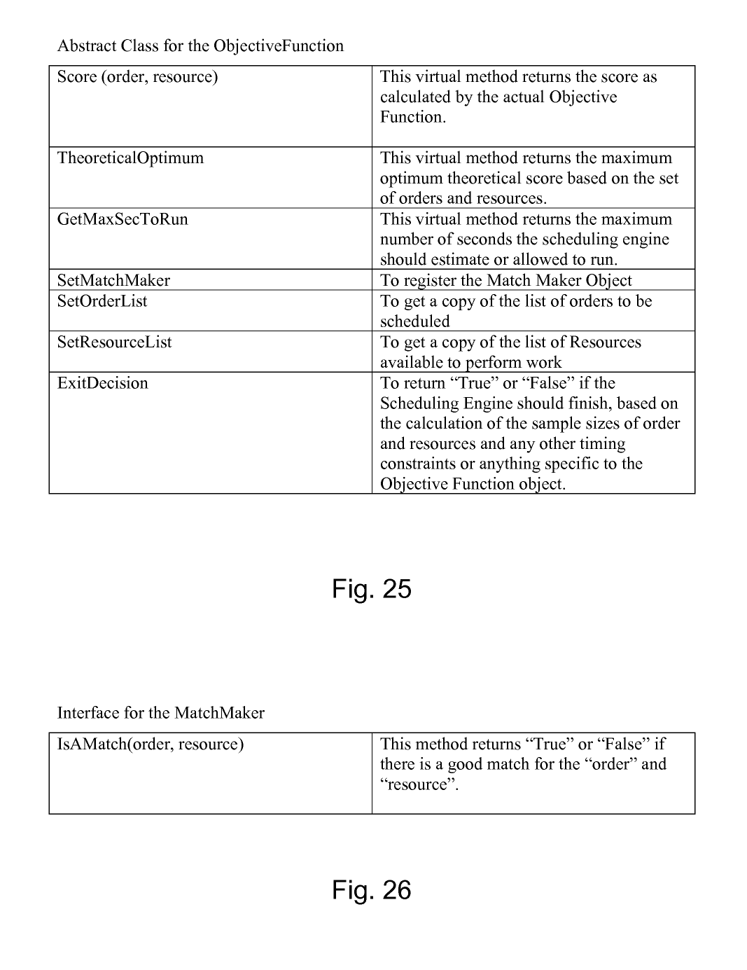

The system's platform architecture enables the integration and application of a plurality of scheduling engines, matching functions, Objective Functions, exit methods, analytical methods, and third party hardware and software functionality. Published software interfaces are made available to supply applicable parameters and methods to incorporate and apply different scheduling engines, matching functions, Objective Functions, Exit Methods, analytical methods and third party software application program interfaces (APIs) that may be created as DLLs and loaded in the server. FIG. 24 illustrates a published interface for scheduling engines. FIG. 25 illustrates a published interface showing methods for Objective Functions. The illustration shows an embodiment in which Exit Methods are defined within the Objective Function. FIG. 26 illustrates a published interface for matching functions. A matching function is also referred to as a MatchMaker.

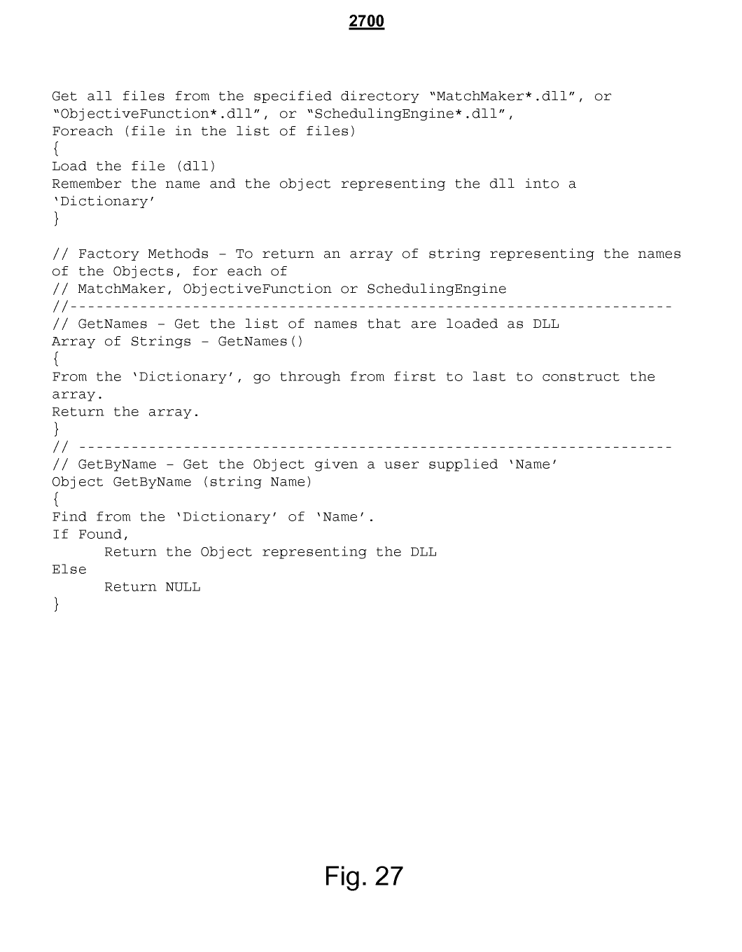

The system employs Factory Classes that manage the DLLs of the scheduling engines, matching functions, Objective Functions, Exit Methods, and analytical methods that may be stored in a specified directory. Factory classes include ScheduleEngineFactory, MatchMakerFactory, and ObjectiveFunctionFactory for the scheduling engines, matching functions and Objective Functions respectively. FIG. 27 illustrates a Factory Constructor 2700 within the Factory Class that retrieves all files from a specified directory that include “MatchMaker*.dll”, “ObjectiveFunction*.dll, and “SchedulingEngine*.dll”. The Factory methods provide the user with a list of available scheduling engines, matching functions and Objective Functions for user selection in the GUI tool. Through the GUI tool the user configures the use of particular scheduling engines, matching functions and Objective Functions in a Schedule Flow. The Schedule Flow supplies the names of the user selected scheduling engines, matching functions and Objective Functions to the system.

Matching functions, Objective Functions and third party software may employ predefined methods of the system through published interfaces. Predefined methods may include Bool MatchPrimaryCsiArea, Bool MatchSecondaryCsiArea, Bool MatchAttributesAll, and Bool MatchAttributesOneOf.

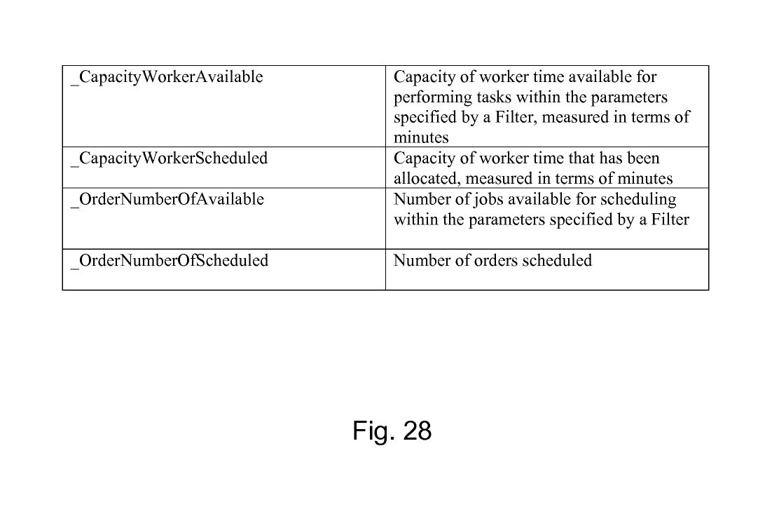

The system may also provide predefined interfaces that provide particular values for evaluative purposes. The interfaces may be employed by user defined screens and analytical tools. FIG. 28 illustrates a published interface that supplies aggregate values to user screens, analytical tools and third party API.

### Flow Chart for the Execution of a Typical Schedule Flow

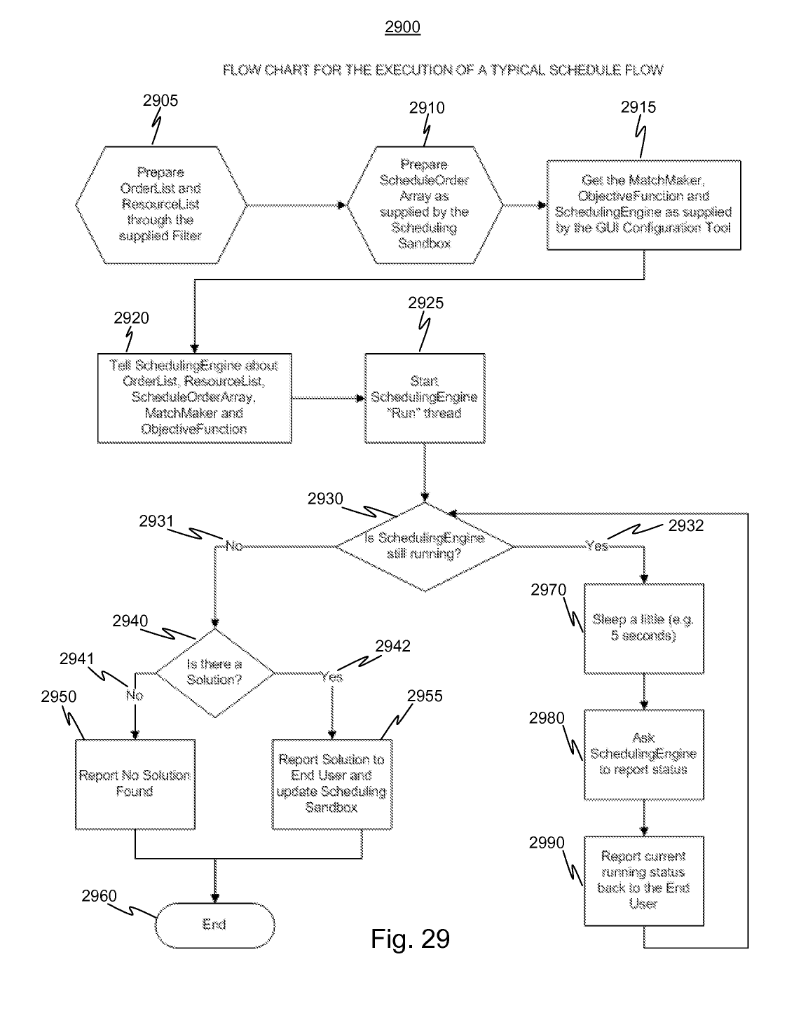

FIG. 29 illustrates a flow chart 2900 that shows the processes for executing a typical Schedule Flow 252. In executing a Schedule Flow the system prepares an order list and resource list in accordance with the parameters of a supplied filter (step 2905). The system then prepares a ScheduleOrder Array as supplied by the Scheduling Sandbox (step 2910). The ScheduleOrder Array represents orders that have been previously scheduled. The matching function, scheduling engine and Objective Function DLLs are retrieved according to the configuration defined in the Schedule Flow through the GUI tool (step 2915). The scheduling engine is supplied with the OrderList, ResourceList, ScheduleOrder Array, Match Maker and Objective Function (step 2920). The system then executes the “Run” thread for the scheduling engine (step 2925), which then runs the “ExecuteTask” method of the specific scheduling engine.

The system applies decision logic (step 2930) to determine if the scheduling engine is still running If the scheduling engine is no longer running (step 2931) further decision logic (step 2940) is applied to determine if a solution has been generated. If a solution has not been generated (step 2941) the system reports that no solution was found (step 2950) and ends the Schedule Flow (step 2960). If a solution was generated (step 2942) the system reports the solution to the end user and updates the Scheduling Sandbox (step 2955), and ends the Schedule Flow (step 2960).

If the system detects that the scheduling engine (step 2932) is still running, the system will sleep for a predefined period, such as 5 seconds (step 2970), after which the scheduling engine will be polled for its running status (step 2980) and the status will be reported to the user (step 2990). After reporting the running status to the user the system will repeat the application of decision logic (step 2930) for determining if the scheduling engine is still running

### State Transition Diagram

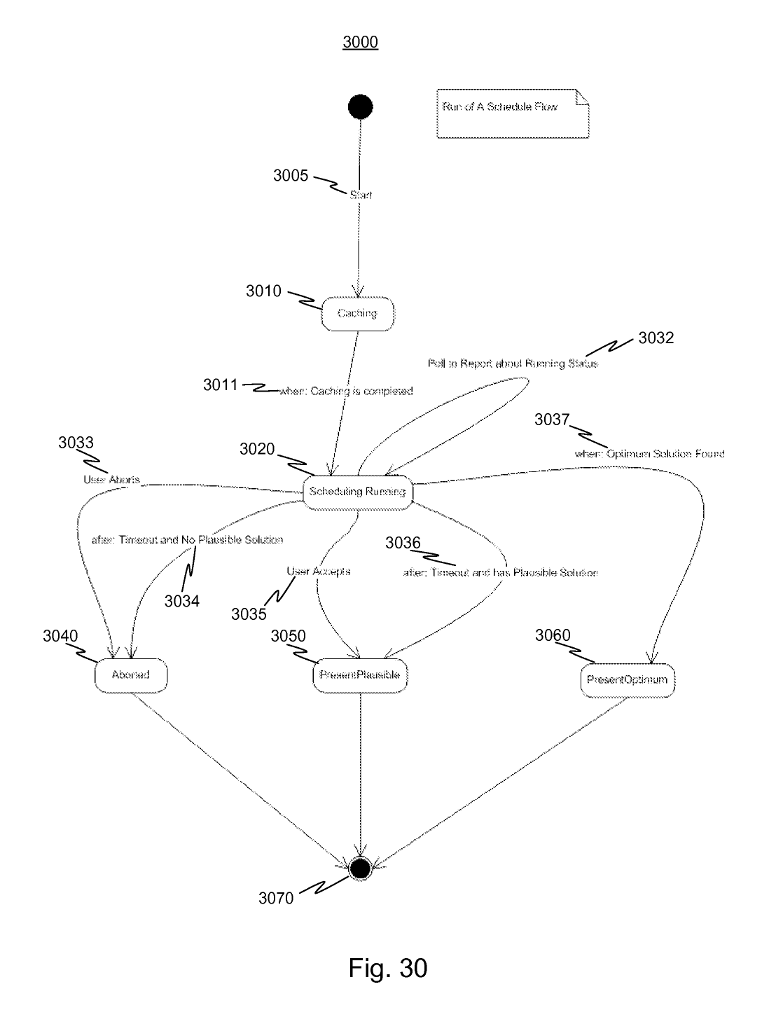

FIG. 30 shows a State Transition diagram that illustrates the process of executing a Schedule Flow 252. A user may start (step 3005) a Schedule Flow by selecting the “Next” option on a user screen.

The system then enters a “Caching” state (step 3010) to cache the necessary data for scheduling, which may include orders that may be based on a named Filter supplied; workers that may be based on a named “Filter” supplied; resources that may be based on a named “Filter” supplied; currently scheduled orders; and workers' shift assignments including skills, attributes, and certification criteria.

When caching is completed (step 3011) the system transitions to the “Scheduling Running” state (step 3020) in which the system runs the user selected scheduling engine, matching function and Objective Function. When running a scheduling engine, such as Squeaky Wheel Optimization (SWO), the system attempts to produce a solution using an algorithm supplied by the scheduling engine DLL, such as a Greedy Algorithm. The system will evaluate solutions using the Objective Function methods and prioritize the scheduling items according to particular criteria defined in the scheduling engine DLL. The system repeats the processes until an optimum solution is determined or until particular conditions defined in the Exit Method are met. The system may employ other scheduling engines including, but not limited to, “Genetic Algorithm” and “Ant colony optimization”.

In an embodiment of the invention the Exit Method may be defined in an Objective Function Object (OFO), which will determine when the Schedule Flow shall stop. The Exit Method condition may be a time-based condition based on the pool size of Orders and Workers. The OFO may apply a predefined time value or apply values entered by the user through the GUI tool 200.

During the “Scheduling Running” state 3020, the scheduling interface will respond to polling (step 3032) of the scheduling status as a feedback loop to the end user. The end user may also choose to “Abort” (step 3033) the Schedule Flow or “Accept” (step 3035) the best plausible solution thus far generated.

The system transitions to the “Aborted” state 3040 when the user selects an “Abort” option (step 3033) or when an Exit Method determines that a time-based condition is met and no plausible solutions are available (step 3034).

The system transitions to the “PresentPlausible” state 3050 when the user selects the “Accept” option (step 3035) to accept a plausible solution, or if the Exit Method determines that the time-based condition is met (step 3036) and at least one plausible solution has been found.

The system transitions to the “PresentOptimum” state 3060 when the Schedule Flow has determined an optimum solution (step 3037) that satisfies the scheduling parameters and objectives within the time constraints that are defined within the Exit Method.

If the user has accepted a plausible solution, or if an optimum solution has been generated, the system will present the scheduling solution on the Sandbox tool. After transitioning to the “Aborted” state 3040, “PresentPlausible” state 3050, or “PresentOptimum” state 3060 the system will show the user screen that is defined within the “Show Screen” function of the Schedule Flow; and thereby completing the Schedule Flow (step 3070). If the Schedule Flow is configured with a “Show Screen” function, the user selection of the ‘Next’ option will further execute a subsequent Schedule Flow as defined in the scheduling logic statement according to the “Show Screen” function. The subsequent Schedule Flow may be configured to employ a scheduling engine, matching function, and OFO that are different from the previous Schedule Flow.

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, or execute acts in a different order than set out in the illustrated embodiments.

The present methods, systems and articles also may be implemented as a computer program product that comprises a computer program mechanism embedded in a computer readable storage medium. For instance, the computer program product could contain program modules for installing and operating the applications described above. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and applications via the use of examples. Insofar as such examples contain one or more functions or operations, it will be understood by those skilled in the art that each function or operation within such examples can be implemented, individually and/or collectively, by a wide range of hardware, software, firmware, or virtually any combination thereof. In one embodiment, the present subject matter may be implemented via Application-Specific Integrated Circuits (ASICs). However, those skilled in the art will recognize that the embodiments disclosed herein, in whole or in part, can be equivalently implemented in standard integrated circuits, as one or more computer programs running on one or more computers, as one or more programs running on one or more controllers (e.g., microcontrollers) as one or more programs running on one or more processors (e.g., microprocessors), as firmware, or as virtually any combination thereof, and that designing the circuitry or writing the code for the software and or firmware would be well within the skill of one of ordinary skill in the art in light of this disclosure.

In addition, those skilled in the art will appreciate that the applications taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

Further, in the methods taught herein, the various acts may be performed in a different order than that illustrated and described. Additionally, the methods can omit some acts, and/or employ additional acts.

These and other changes can be made to the present systems, methods and applications in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

What is claimed is:

1. A computer readable memory storing a computer program executable by a processor, for producing a user interface scheduling tool for scheduling a first scheduling population to a second scheduling population using a Schedule Run, comprising:
a graphical user interface for use in the simultaneous creation and configuration of each step of the Schedule Run, wherein each step of the Schedule Run comprises
at least one Schedule Flow and an associated display area; and
a sandbox tool and associated display area for the implementation of said Schedule Run.

2. The computer readable memory storing a computer program executable by a processor, for producing a user interface scheduling tool of claim 1 wherein said first scheduling population comprises a resource and said second scheduling population comprises a job.

3. The computer readable memory storing a computer program executable by a processor, for producing a user interface scheduling tool of claim 1 wherein said graphical user interface simultaneously provides a Schedule Flow Editor for creating and configuring a Schedule Flow by the creation, selection and editing of at least one of: a scheduling logic statement or a prerequisite; a Screen Editor for editing a user screen associated with said Schedule Flow; and a Fields Menu for selecting and/or creating a plurality of data fields for creating scheduling logic statements; and
a context sensitive editor for editing said scheduling logic statements and prerequisites;
and wherein said prerequisites include filters, scheduling engines, matching functions, objective functions and exit functions.

4. The computer readable memory storing a computer program executable by a processor, for producing a user interface scheduling tool of claim 1 wherein said data fields include repeatable fields.

5. The computer readable memory storing a computer program executable by a processor, for producing a user interface scheduling tool of claim 3 wherein prerequisites include filters and optimizers.

6. The computer readable memory storing a computer program executable by a processor, for producing a user interface scheduling tool of claim 5 wherein said optimizers include scheduling engines, matching functions, objective functions and exit functions.

7. The computer readable memory storing a computer program executable by a processor, for producing a user interface scheduling tool of claim 6 wherein said optimizers are integrated as extensible code.

8. The computer readable memory storing a computer program executable by a processor, for producing a user interface scheduling tool of claim 7 wherein said extensible code is provided access to one or more of said data fields.

9. The computer readable memory storing a computer program executable by a processor, for producing a user interface scheduling tool of claim 1 wherein said Schedule Run is storable as a Schedule_Type.

10. The computer readable memory storing a computer program executable by a processor, for producing a user interface scheduling tool of claim 5 wherein said filter isolates one of said scheduling populations according to a condition.

11. The computer readable memory storing a computer program executable by a processor, for producing a user interface scheduling tool of claim 1 wherein an editor of the Schedule Flow creates and configures said Schedule Flow by the creation, selection and editing of at least one of a scheduling logic statement or a prerequisite and wherein said prerequisite employs a scheduling engine, matching function, objective function and exit function to optimize said Schedule Flow.

12. A system for scheduling a first scheduling population to a second scheduling population using a Schedule Run, comprising:
a graphical user interface tool having:
means for the simultaneous creation and configuration of each step of the Schedule Run, wherein each step of the Schedule Run comprises a Schedule Flow;
means for configuring said Schedule Flow by selecting and editing at least one of scheduling logic statements and a prerequisite element; and
means to configure a sandbox tool for the implementation of said Schedule Run.

13. The system of claim 12 wherein said first scheduling population comprises a resource, and said second scheduling population comprises a job.

14. The system of claim 12 further comprising means for storing a definition associated with said Schedule Run and a Schedule Flow configuration, said Schedule Flow configuration including a user screen definition, a scheduling logic statement configuration, and a prerequisite configuration.

15. The system of claim 12 wherein said Schedule Run is stored as a Schedule_Type.

16. The system of claim 12 wherein said prerequisite includes a filter that isolates one of said scheduling populations according to a condition.

17. The system of claim 12 wherein said prerequisite employs a scheduling engine, a matching function, an objective function and an exit function to optimize said Schedule Flow.

18. A method of allocating a first scheduling population to a second scheduling population, comprising:
configuring a Schedule Run with a Schedule Flow for each step of said Schedule Run;
simultaneously configuring a user screen for each of said Schedule Flow;
simultaneously configuring said Schedule Flow by selecting and editing a scheduling logic statement;
simultaneously configuring said Schedule Flow by selecting and editing a prerequisite element;
storing a Schedule Flow configuration, including a user screen definition, said scheduling logic statement, and said prerequisite configuration as part of a Schedule Run;
storing said Schedule Run as a Schedule_Type; and
running said Schedule_Type to optimize allocation of said first scheduling population to said second scheduling population.

19. The method of claim 18 wherein said first scheduling population comprises a resource, and said second scheduling population comprises a job.

20. The method of claim 18 wherein said Schedule Run is optimized using said prerequisite element that includes a scheduling engine, a matching function, an objective function and an exit function.

21. The method of claim 18 wherein one of said prerequisite elements is a filter having a condition, and said Schedule Run filters said scheduling populations according to said condition.

22. The method of claim 18 wherein said Schedule Run is initiated via a sandbox tool, said sandbox tool, before said Schedule Run is initiated, showing unallocated and allocated members of said scheduling populations and a proposed allocation of said scheduling populations as generated by processing of said Schedule Flow.

23. The method of claim 22 wherein said sandbox tool allows input, definition and modification of a parameter for said prerequisite element.

24. The method of claim 22 wherein said sandbox tool allows a user to commit, cancel, and manually override and modify said proposed allocation of scheduling populations as generated by said processing of said Schedule Flow.

25. The method of claim 22 wherein said sandbox tool allows a user to apply options including locking down and floating a user selected scheduling item.

26. The method of claim 20 wherein said scheduling engine, matching function, objective function, and exit method, are integrated and applied as extensible code.

27. The method of claim 26 wherein said extensible code includes analytical methods and third party software application program interfaces.

28. The method of claim 26 wherein said extensible code is integrated through a published interface.

29. The method of claim 28 wherein said published interface include predefined interfaces that provide values to user screens, analytical tools and third party application program interfaces (API).

30. The method of claim 18 wherein said Schedule Run can be run in batch mode.

31. The method of claim 30 wherein a system task is configured to invoke said Schedule Run to be run in batch mode.

32. The method of claim 30 wherein a screen presentation for said Schedule Flow of said Schedule Run is logged in a database.

33. The method of claim 18 wherein the allocation of scheduling populations generated from the processing of said Schedule Run is automatically committed.
